(19) United States
(12) Patent Application Publication
(10) Pub. No.: US 2024/0214562 A1
(43) Pub. Date: Jun. 27, 2024

(54) VIDEO CODING WITH DYNAMIC GROUPS OF PICTURES

(71) Applicant: HUAWEI TECHNOLOGIES CO., LTD., Shenzhen (CN)

(72) Inventors: Sergey Yurievich Ikonin, Moscow (RU); Nicola GIULIANI, Munich (DE); Biao Wang, Shenzhen (CN); Elena Alexandrovna Alshina, Munich (DE); Han Gao, Shenzhen (CN)

(21) Appl. No.: 18/412,589

(22) Filed: Jan. 14, 2024

Related U.S. Application Data
(63) Continuation of application No. PCT/RU2021/000299, filed on Jul. 13, 2021.

(51) Int. Cl. H04N 19/114; H04N 19/136; H04N 19/177; H04N 19/184; H04N 19/42; H04N 19/587

(52) U.S. Cl. CPC H04N 19/114; H04N 19/136; H04N 19/177; H04N 19/184; H04N 19/42; H04N 19/587

(57) ABSTRACT

An apparatus for generating a bitstream representing input frames of a video sequence, is provided. The apparatus includes a processing circuitry configured to generate the bitstream including a synthesized frame at a first position of a first input frame based on two or more input frames. A quality measure for the synthesized frame is determined. Based on determining that the quality measure fulfills a predetermined condition, an indication of the first position is included into a bitstream portion, and based on determining that the quality measure does not fulfill the predetermined condition, content of the first input frame is encoded into the bitstream portion.

### CROSS-REFERENCE TO RELATED APPLICATIONS

This application is a continuation of International Application No. PCT/RU2021/000299, filed on Jul. 13, 2021, the disclosure of which is hereby incorporated by reference in its entirety.

### FIELD

The present disclosure generally relates to the field of video compression. For example, the present disclosure relates to compression of video sequences in dynamic groups of pictures.

### BACKGROUND

Video coding (video encoding and decoding) is used in a wide range of digital video applications, for example broadcast digital TV, video transmission over internet and mobile networks, real-time conversational applications such as video chat, video conferencing, DVD and Blu-ray discs, video content acquisition and editing systems, and camcorders of security applications.

The amount of video data needed to depict even a relatively short video can be substantial, which may result in difficulties when the data is to be streamed or otherwise communicated across a communications network with limited bandwidth capacity. Thus, video data is generally compressed before being communicated across modem day telecommunications networks. The size of a video could also be an issue when the video is stored on a storage device because memory resources may be limited. Video compression devices often use software and/or hardware at the source to code the video data prior to transmission or storage, thereby decreasing the quantity of data needed to represent digital video pictures. The compressed data is then received at the destination by a video decompression device that decodes the video data. With limited network resources and ever increasing demands of higher video quality, improved compression and decompression techniques that improve compression ratio with little to no sacrifice in picture quality are desirable.

The encoding and decoding of the video may be performed by standard video encoders and decoders, compatible with H.264/AVC, HEVC (H.265), VVC (H.266) or other video coding technologies, for example.

Transmission resources are typically limited so that compression of the transferred data may be desirable. In general, compression may be lossless (e.g. entropy coding) or lossy (e.g. applying quantization). The lossy compression typically provides a higher compression ratio. However, it is in general irreversible, i.e. some information may be irrecoverably lost.

### SUMMARY

Methods and apparatuses according to this disclosure allow compression of video sequences where synthetic frames are used in dynamic groups of pictures.

Some implementations of the present disclosure relate to compression of video sequences where synthetic frames are used in dynamic groups of pictures so as to generate at low bit costs a bitstream including only a few encoded input frames and position indications for synthetic frames without encoding them.

In this disclosure a synthetic frame may be also referred to as synthesized frame. A frame may also refer to a picture or a frame of a picture or picture frame.

According to an aspect of the present disclosure, an apparatus is provided for generating a bitstream representing input frames of a video sequence, the apparatus comprising: a processing circuitry configured to generate the bitstream including: generating a synthesized frame at a first position of a first input frame based on two or more input frames; determining a quality measure for the synthesized frame; when the quality measure fulfills a predetermined condition, including an indication of said first position into a bitstream portion; and when the quality measure does not fulfill the predetermined condition, encoding content of said first input frame into the bitstream portion. Accordingly, the bit costs for the generated bitstream is reduced, improving the compression without increase of encoding latency.

In one exemplary implementation, the generating of the synthesized frame includes interpolating the synthesized frame based on one or more input frames preceding the synthesized frame and on one or more input frames succeeding the synthesized frame in a display order. Accordingly, the generated S frame may entail time correlation from preceding and succeeding frames, and thus lead to a more accurate interpolation and thus closer match with the original frame.

For example, the generating of the synthesized frame is performed by a neural network. Accordingly, the generating of the bitstream may be performed with a trained network optimized for frame interpolation. Hence, the interpolation and thus determination of whether or not an S frame should be generated may be performed accurately. This may lead to a larger reduction of rate of the coded bitstream.

According to an implementation, the quality measure is any of peak signal to noise ratio, PSNR, resolution, bit depth, or a perceptual quality metric. Accordingly, different kinds of known quality measures may be used for the synthesized frame. A particular quality metric may be selected, based on a specific application. Using resolution and/or bit depth may be simple and thus efficient as they do not require any additional computation effort. On the other hand, PSNR is a widely used objective metric, whereas a perceptual metric (e.g. an estimator of subjective opinion score) may further reduce bitrate without compromising user experience.

In another implementation example, said first input frame, when the quality measure does not fulfill the predetermined condition, can be coded as any of an intra-predicted frame I, an unidirectional inter-prediction frame P and a bidirectional inter-prediction frame B, corresponding respectively to frame types I, P, and B. Accordingly, an input frame to be coded may be assigned any of frame types I, B, or P, which have different bit cost. Therefore, the bit costs may be optimized based on the assigned frame type.

According to an implementation, the synthesized frame is generated from the two or more input frames, and the indication indicates said first position within a Group of Pictures, GOP, at which the synthesized frame is to be generated. Accordingly, the first position is signaled in the bitstream with a simple indication. This reduces the signaling overhead.

For example, a number of synthesized frames generated for the GOP is based on a predefined look ahead constant determining a maximum number of synthesized frames that can be generated for the GOP. Accordingly, the number of synthesized frames may be adapted within a range of the look ahead constant. Therefore, the S frame determination may be performed in a flexible manner, enabling a dynamic adaptivity of the GOP.

In a further implementation, the GOP includes two or more coded frames comprising a starting frame having the frame type I and an ending frame of the GOP, and the processing circuitry is further configured to: assign one of frame types P and B in accordance with a predefined GOP pattern of frame types to each of the frames within the GOP different from the starting frame; and encode the content of the each of the frames within the GOP into the bitstream portion. Accordingly, the frames to be encoded are determined based on a GOP pattern, allowing for tuning the sequence of coded frames within a predefined GOP structure. This may be beneficial especially for applications which may require fixed GOP size.

In a further implementation, the indication of said first position includes positions of the coded frames. Therefore, by generating a bitstream according to a predefined look ahead constant and a GOP pattern, the GOP may be adaptively enlarged.

According to an implementation, the processing circuitry is further configured to: detect a scene change based on the frames of the GOP; and assign the frame to be encoded at which the scene change occurs the frame type I. Accordingly, frame types within the GOP may be adapted depending on the degree of scene change. Hence, the bit costs may be optimized in account of the degree and occurrence of scene changes.

For example, said first input frame pertains to a Group of Pictures, GOP, of a predefined GOP structure, and the processing circuitry is configured to: when the quality measure does not fulfill the predetermined condition, encode the content of said first input frame into the bitstream portion with a frame type according to a GOP pattern of frame types pre-configured for said GOP; and when the quality measure fulfills the predetermined condition, not encode the content of said first input frame into the bitstream portion.

According to an exemplary implementation, the processing circuitry is configured to: determine a set of one or more positions including said first position within the GOP, the GOP including, as coded input frames, a starting frame with a start position and an ending frame with an end position, wherein the start position and the end position are in display order, generate recursively, in coding order, the synthesized frame at a current position between the start position and the end position from the starting frame and the ending frame; determine the quality measure for the synthesized frame; when the quality measure fulfills the predetermined condition, include the indication of the current position into the bitstream portion; when the quality measure does not fulfill the predetermined condition, encode the content of an input frame at the current position into the bitstream portion; and continue the recursion using the coded frames or the synthesized frames at the start position and the current position, and/or at the current position and the end position. Accordingly, the determination which frame of the GOP should be replaced is performed during the encoding process (on-the-fly determination), because both coded frames and already synthesized frames are used. Hence, pre-processing may be reduced, accelerating the generation of the bitstream.

In an example, the processing circuitry is further configured to put the synthesized frame and/or the coded frame at the first position into a decoded frame buffer if one or more frames depend on the frame at said first position. Accordingly, coded and/or synthesized frames are available in case of frame dependencies. Thus, the determination of S frames at higher hierarchy level may be performed while preserving frame dependencies.

According to an implementation, the processing circuitry is configured to determine a set of one or more positions, including said first position, of a next coded frame within a Group of Pictures, GOP, the GOP including, as coded input frames, a starting frame with a start position and an ending frame with an end position, wherein the start position and the end position are in display order, including: generating for a GOP size and a predefined look ahead constant recursively in coding order one or more synthesized frames at a respective current position between the start position and the end position from the starting frame and the ending frame; determining the quality measure for each of the synthesized frames; when the quality measure fulfills the predetermined condition for each of the synthesized frames: determining the ending frame as the next frame to be encoded and encode the content of the ending frame at the end position into the bitstream portion; when the quality measure does not fulfill predetermined condition for any of the one or more synthesized frames: continuing the recursion by bisecting the GOP size and using the start position and the end position of the input frames of the respective bisected GOP; or determining the coded input frame immediately following the starting frame in the display order as the next frame to be encoded and encode the content of an input frame at the respective current position into the bitstream portion; wherein the predefined look ahead constant determines a maximum number of the synthesized frames that can be generated for the GOP. Accordingly, the number of synthesized frames that are to be generated for the GOP is determined and dynamically adapted during the encoding process.

For example, the GOP size and bisected GOP sizes correspond to differences in position between successive next frames to be encoded into the bitstream portion. Accordingly, positions of next coded frames can be determined easily from GOP sizes.

In another implementation, the one or more preceding frames and the one or more succeeding frames in display order being neighboring frames of the synthesized frame, respectively.

Moreover, an amount of one or more neighboring frames being any of a number ranging from 1 to 64. Accordingly, the S frame may be generated via simple bi-directional interpolation or higher order schemes by including an increased number of preceding and succeeding frames, which may ne neighboring the S frame. As a result, an S frame may be generated entailing time correlation from preceding and/or succeeding frames at various degree. Hence, the inter-frame correlation may be tunable e.g. depending on the content of the S frame and/or content of the preceding and succeeding frames.

According to an aspect of the present disclosure, an apparatus is provided for generating frames of a video sequence from a bitstream representing the video sequence, the apparatus comprising: a processing circuitry configured to generate the frames including: decoding from a bitstream portion of the bitstream content of two or more frames of the video sequence; parsing the bitstream portion for an indication of a first position; and generating, based on the parsed indication, a synthesized frame as a frame of the video sequence at said first position based on two or more previously generated frames. Accordingly, the decoder is able to decode content and position indication from a lightweight bitstream. Thus, the generating of frames for a GOP may be accelerated.

According to an implementation, the generating of the synthesized frame includes interpolating the synthesized frame based on one or more previously generated frames preceding the synthesized frame and on one or more previously generated frames succeeding the synthesized frame in a display order. Accordingly, the generated S frame may entail time correlation from preceding and succeeding frames, and thus lead to a more accurate interpolation and thus closer match with the original frame.

For example, the generating of the synthesized frame is performed by a neural network. Accordingly, the generating of the bitstream may be performed with a trained network optimized for frame interpolation. Hence, the generated S frame may be performed accurately.

In another implementation, the decoded two or more frames being any of an intra-predicted frame I, an unidirectional inter-prediction frame P, and a bidirectional inter-prediction frame B, corresponding to frame types I, P, and B.

In a further implementation, the indication indicates said first position within a Group of Pictures, GOP, at which the synthesized frame is generated. Accordingly, the decoder knows where to generate a synthesized frame within the GOP.

For example, the indication of said first position includes positions of the decoded two or more frames, with said first position and the positions of the decoded two or more frames being in display order of the GOP. Accordingly, the decoder knows the positions of decoded frames within the GOP.

According to an implementation, the processing circuitry is further configured to put the decoded two or frames into a decoded frame buffer if one or more frames depend on the frame at said first position. Accordingly, decoded frames are available in case of frame dependencies. Thus, S frames which may depend on decoded frames may be generated accurately at higher hierarchy level while preserving frame dependencies.

In a further implementation, the GOP includes two or more decoded frames comprising a starting frame an ending frame of the GOP, the starting frame having frame type I and the ending frame having a frame type B or P, and the processing circuitry is further configured to: determine, based on the parsed indication, a position difference between the two decoded frames having successive positions in display order; determine, based on the position difference, a number of synthesized frames generated in display order between the two decoded frames; and generate in decoding order the synthesized frames in accordance with the number at respective positions between the two decoded frames based on the position difference.

In another implementation, the two or more decoded frames of the GOP include one or more decoded frames of frame type I having a corresponding position in display order between the starting frame and the ending frame of the GOP. Accordingly, the frames of the GOP include frames of frame type I between the starting frame and the ending frame, representing access points for video content at which a scene change occurs.

According to a further implementation, the synthesized frame pertains to a Group of Pictures, GOP, of a predefined GOP structure, and the indication indicates said first position within the GOP at which the synthesized frame is generated. Accordingly, the decoder knows where to generate a synthesized frame within the GOP with a fixed (i.e. predefined) GOP structure.

For example, the GOP includes two or more already generated frames, the GOP comprising a starting frame with a start position and an ending frame with an end position, wherein the start position and the end position are in display order, and the processing circuitry is further configured to recursively: parse the bitstream for the indication of a current position, the current position being between the start position and the end position; when said indication is parsed: generate in decoding order the synthesized frame at the current position from the starting frame and the ending frame; when said indication is not parsed: decode from the bitstream portion content of a current frame being at the current position; continue the recursion using the starting frame and, as the ending frame, the synthesized frame or the decoded frame at the current position, and/or respectively using, as the starting frame, the synthesized frame or the decoded frame at the current position, and the ending frame. Accordingly, the frames of the GOP are generated using both decoded frames or already synthesized frames. Hence, frame of the GOP may be generated from a reduced number of decoded frames as a result of the lightweight bitstream.

In an implementation, the processing circuitry is further configured to put the generated frame into a decoded frame buffer if one or more generated frames depend on the frame at said first position. Accordingly, decoded frames are available in case of frame dependencies. Thus, S frames which may depend on decoded frames may be generated accurately at higher hierarchy level while preserving frame dependencies.

In another implementation, the indication indicates said first position within a Group of Pictures, GOP, at which the synthesized frame is generated and the bitstream portion includes an indication of one or more GOP sizes. Accordingly, the decoder knows the position of the S frame to be generated, as well as the positions of next coded frames based on the GOP sizes.

For example, the GOP size corresponds to a difference in position between successive decoded frames. Accordingly, the positions at which S frames are generated within the GOP may be easily determined from the GOP sizes.

According to an implementation, the GOP comprises already two decoded frames used as a starting frame with a start position and an ending frame with an end position, wherein the start position and the end position are in display order, and the processing circuitry is further configured to recursively: parse the bitstream portion for the indication of a first GOP size among the one or more GOP sizes; generate for said first GOP size in decoding order one or more synthesized frames at a respective current position in display order between the start position and the end position from the starting frame and the ending frame; continue the recursion using, as the starting frame, the ending frame of previous recursion step and using, as the ending frame, the decoded frame based on a next GOP size subsequent to said first GOP size.

In a further implementation, the one or more preceding and/or succeeding already generated frames in display order being neighboring frames of the synthesized frame, respectively.

For example, an amount of one or more neighboring frames being any of a number ranging from 1 to 64. Thus, an S frame may be generated in a flexible manner, exploiting previously generated frames at varying number (both preceding and succeeding frames) as well as the degree of being neighboring to the S frame to be generated. Accordingly, the frames of the vide sequence may be generated accounting for inter-frame correlations at different degree.

According to an aspect of the present disclosure, a method is provided for generating a bitstream representing input frames of a video sequence, the method comprising steps of generating the bitstream including: generating a synthesized frame at a first position of a first input frame based on two or more input frames; determining a quality measure for the synthesized frame; when the quality measure fulfills a predetermined condition: including an indication of said first position into a bitstream portion; and when the quality measure does not fulfill the predetermined condition: encoding content of said first input frame into the bitstream portion.

According to an aspect of the present disclosure, a method is provided for generating frames of a video sequence from a bitstream representing the video sequence, the method comprising steps of generating the frames including: decoding from a bitstream portion of the bitstream content of two or more frames of the video sequence; parsing the bitstream portion for an indication of a first position; and generating, based on the parsed indication, a synthesized frame as a frame of the video sequence at said first position based on two or more previously generated frames.

The methods provide similar advantages as the apparatuses performing the corresponding steps and described above.

According to an aspect of the present disclosure, provided is a computer-readable non-transitory medium storing a program, including instructions which when executed on one or more processors cause the one or more processors to perform the method according to any of the above implementations.

According to an aspect of the present disclosure, an apparatus is provided for generating a bitstream representing input frames of a video sequence, the apparatus comprising: one or more processors; and a non-transitory computer-readable storage medium coupled to the one or more processors and storing programming for execution by the one or more processors, wherein the programming, when executed by the one or more processors, configures the apparatus to carry out the method for generating a bitstream representing input frames of a video sequence.

According to an aspect of the present disclosure, an apparatus is provided for generating frames of a video sequence from a bitstream representing the video sequence, the apparatus comprising: one or more processors; and a non-transitory computer-readable storage medium coupled to the one or more processors and storing programming for execution by the one or more processors, wherein the programming, when executed by the one or more processors, configures the apparatus to carry out the method for generating frames of a video sequence from a bitstream representing the video sequence.

According to an aspect of the present disclosure, provided is a computer program comprising a program code for performing the method when executed on a computer according to any one of the above methods.

The aspects of the present disclosure and examples mentioned above can be implemented in hardware (HW) and/or software (SW) or in any combination thereof. Moreover, HW-based implementations may be combined with SW-based implementations.

### BRIEF DESCRIPTION OF THE DRAWINGS

In the following, embodiments of the invention are described in more detail with reference to the attached figures and drawings, in which

FIG. 1 is an illustration of frames having frame types I, P, and B, along with their respective blocks (inter-predicted, uni-directional inter-predicted, bi-directional inter-predicted). The bottom part illustrates bi-directional interpolation for S frame.

FIG. 2 is an example of a low delay configuration in HEVC, where the decoding order and the display order is same.

FIG. 3 is an example of a random access configuration, where the decoding order and the display order are different.

FIG. 4A is an illustration of a frame sequence of a GOP, which has a dynamic GOP structure according to an embodiment.

FIG. 4B is a table illustrating the frames in a buffer at each step of the processing in generating synthesized frame(s) and assigning frame types according to an embodiment.

FIG. 5A is an illustration of a frame sequence of a GOP, which has a dynamic GOP and inserting I frame into the GOP structure at a position of scene change according to an embodiment.

FIG. 5B is a table illustrating the frames in a buffer at each step of the processing in generating synthesized frame(s) similar to embodiment 1, but assigning frame type I according to an embodiment.

FIG. 6 is an illustration of a frame sequence of a GOP, with a fixed GOP structure and S frames generated without change of GOP structure according to an embodiment.

FIG. 7 is an illustration of determining dynamic GOP size for low delay according to an embodiment.

FIG. 8 is a block diagram illustrating an exemplary apparatus for generating a bitstream representing input frames of a video sequence according to an embodiment.

FIG. 9 is a block diagram illustrating an exemplary apparatus for generating frames of a video sequence from a bitstream representing the video sequence according to an embodiment.

FIG. 10 is a flowchart illustrating an exemplary method for generating a bitstream representing input frames of a video sequence according to an embodiment.

FIG. 11 is a flowchart illustrating an exemplary decoding method for generating frames of a video sequence from a bitstream representing the video sequence according to an embodiment.

FIG. 12 is a block diagram showing an example of a video encoder configured to implement embodiments of the invention.

FIG. 13 is a block diagram showing an example structure of a video decoder configured to implement embodiments of the invention.

FIG. 14 is a block diagram showing an example of a video coding system configured to implement embodiments of the invention.

FIG. 15 is a block diagram showing another example of a video coding system configured to implement embodiments of the invention.

FIG. 16 is a block diagram illustrating an example of an encoding apparatus or a decoding apparatus.

FIG. 17 is a block diagram illustrating another example of an encoding apparatus or a decoding apparatus.

### DETAILED DESCRIPTION

In the following description, reference is made to the accompanying figures, which form part of the disclosure, and which show, by way of illustration, aspects of embodiments of the present disclosure or aspects in which embodiments of the present disclosure may be used. It is understood that embodiments of the present disclosure may be used in other aspects and comprise structural or logical changes not depicted in the figures. The following detailed description, therefore, is not to be taken in a limiting sense.

For instance, it is understood that a disclosure in connection with a described method may also hold true for a corresponding device or system configured to perform the method and vice versa. For example, if one or a plurality of method steps are described, a corresponding device may include one or a plurality of units, e.g. functional units, to perform the described one or plurality of method steps (e.g. one unit performing the one or plurality of steps, or a plurality of units each performing one or more of the plurality of steps), even if such one or more units are not explicitly described or illustrated in the figures. On the other hand, for example, if an apparatus is described based on one or a plurality of units, e.g. functional units, a corresponding method may include one step to perform the functionality of the one or plurality of units (e.g. one step performing the functionality of the one or plurality of units, or a plurality of steps each performing the functionality of one or more of the plurality of units), even if such one or plurality of steps are not explicitly described or illustrated in the figures. Further, it is understood that the features of the various exemplary embodiments and/or aspects described herein may be combined with each other, unless noted otherwise.

Video coding typically refers to the processing of a sequence of pictures, which form the video or video sequence. Instead of the term picture, the terms frame or image may be used as synonyms in the field of video coding. Video coding comprises two parts, video encoding and video decoding. Video encoding is performed at the source side, typically comprising processing (e.g. by compression) the original video pictures to reduce the amount of data that may be required for representing the video pictures (for more efficient storage and/or transmission). Video decoding is performed at the destination side and typically comprises the inverse processing compared to the encoder to reconstruct the video pictures. Embodiments referring to “coding” of video pictures (or pictures in general) shall be understood to relate to both, “encoding” and “decoding” of video pictures. The combination of the encoding part and the decoding part is also referred to as CODEC (COding and DECoding).

In case of lossless video coding, the original video pictures can be reconstructed, i.e. the reconstructed video pictures have the same quality as the original video pictures (assuming no transmission errors or other data loss during storage or transmission). In case of lossy video coding, further compression, e.g. by quantization, is performed, to reduce the amount of data representing the video pictures, which cannot be completely reconstructed at the decoder, i.e. the quality of the reconstructed video pictures is lower or worse compared to the quality of the original video pictures.

Several video coding standards since H.261 belong to the group of “lossy hybrid video codecs” (i.e. combine spatial and temporal prediction in the sample domain and 2-D transform coding for applying quantization in the transform domain). Each picture of a video sequence is typically partitioned into a set of non-overlapping blocks and the coding is typically performed on a block level. In other words, at the encoder the video is typically processed, i.e. encoded, on a block (video block) level, e.g. by using spatial (intra picture) prediction and temporal (inter picture) prediction to generate a prediction block, subtracting the prediction block from the current block (block currently processed/to be processed) to obtain a residual block, transforming the residual block and quantizing the residual block in the transform domain to reduce the amount of data to be transmitted (compression), whereas at the decoder the inverse processing compared to the encoder is applied to the encoded or compressed block to reconstruct the current block for representation. Furthermore, the encoder duplicates the decoder processing loop such that both will generate identical predictions (e.g. intra- and inter-predictions) and/or re-constructions for processing, i.e. coding, the subsequent blocks.

As video picture processing (also referred to as moving picture processing) and still picture processing (the term processing comprising coding), share many concepts and technologies or tools, in the following the term “picture” is used to refer to a video picture of a video sequence (as explained above) and/or to a still picture to avoid unnecessary repetitions and distinctions between video pictures and still pictures, where not necessary. In case the description refers to still pictures (or still images) only, the term “still picture” shall be used.

In the following, an overview over some of the used technical terms is provided.

Intra-prediction: Predicting a block of samples for a current frame using samples only within the same current frame. Said same frame has no dependency on other frames within a video sequence. This is also referred to as spatial prediction.

Inter-prediction: Predicting a block of samples for a current frame of a vide sequence using samples of one or more other frames temporally different from the current frame. The current frame has a temporal dependency with the other frames. This is also referred to as temporal prediction.

Frame types: As will be explained further below, in the present disclosure, four frame types are defined, namely I, P, and B frames. In some embodiments, a new frame type, i.e. synthetic frame (S frame, may be also referred to as synthesized frame) is introduced. The Synthetic frame is generated, for example, by frame interpolation from a frame generation module, taking a frame backward (preceding) and a frame forward (following) of the synthetic frame as input. The preceding frame may be a frame directly (immediately) preceding the position of the synthesized frame in some embodiments. In other embodiments, the preceding frame may be any (predetermined) frame from the same GOP preceding the S-frame. The following frame may be a frame directly (immediately) following the position of the synthesized frame in some embodiments. In other embodiments, the following frame may be any (predetermined) frame from the same GOP following the S-frame.

Display order: Refers to the order in which frames are displayed after decoding.

Coding order: Refers to the order in which frames are coded, encoded, or decoded.

Group Of Pictures (GOP): Refers to a group of successive pictures within a video sequence. The coding order of frames in a GOP might not be the same to their display order.

Encoding decoding delay: Encoding/decoding delay occurs, when the display order and the coding order in a GOP are different. A frame in the GOP might not depend on previous frames in display order, but might also depend on future frames in display order. Therefore, an encoding/decoding latency between the current frame and the future frame occurs, because the encoder/decoder has to encode/decode first the future frame and then the current frame to fulfil the dependency between them.

GOP structure: Refers to the frame types assigned to each frame in a GOP, and their coding order/dependency in between.

All Intra configuration: Refers to a video coding configuration wherein only intra-prediction is allowed. Each frame has no dependency on any other frame. Within such an encoded sequences, the decoder can seek any frame and start decoding.

Random access configuration: Refers to a video coding configuration in which the display order and the coding order of frames are different. In this configuration, typically I frames are spread across a video sequence, which the decoder seeks for and start decoding of an I frame. Typically, a GOP structure is defined in this configuration for every N frames, with every N frames is a GOP.

Low delay configuration: Refers to a video coding configuration in which the display order and the coding order of frames are the same. A current frame only depends on one or more previous frames in display order. No future frame in display order is coded before the current frame. Therefore, no decoding latency exists between a given frame and its future frames. A low delay configuration usually has only one I frame at the beginning, and the decoder cannot seek for a random frame to be decoded, because the frame at the sought position depends on previous frames, which might not be decoded yet.

Frame rate: Refers to how many frames for given a period of a time interval T are processed, e.g. decoding/encoding/displayed. It is usually quantified in the unit of frames/second (i.e. frames per second fps).

Peak Signal-to-Noise Ratio (PSNR): PSNR is a metric commonly used to quantify the reconstruction quality of an image compared to its original image. The higher the PSNR the better quality of reconstructed images.

Coded frame: Refers to a frame encoded by an existing codec, but not synthesized by an interpolation module. A coded frame can be an I, P, or B frame.

Video compression is achieved by removing redundancy in a video sequence. Two kinds of redundancy are usually exploited: temporal redundancy and spatial redundancy.

In most instances, the content of successive frames in a video sequence may not change too much. This means that, within such kind of successive frames, only a small motion for specific objects are observed. In such cases, only motion information is recorded/encoded for those frames (except for the first “anchor” frame e.g. an I frame). To recover these frames in the decoder (except for the first “anchor” frame e.g. an I frame), a temporal prediction (i.e. inter-prediction) is performed with the decoded anchor frame and the motion information as inputs. In such a way, these non-anchor frames avoid encoding all the information of a frame, and thus reduces the temporal redundancy. In video coding convention, non-anchor frames are usually called inter frames because temporal prediction relies on an inter-picture correlation. Inter-picture correlation means that a temporal correlation between at least two pictures (or frames) at different time instances (time points) exists. The anchor frame is referred to as reference picture, and motion information is represented by motion vectors. Sometimes, the inter-prediction can be performed not only uni-directional, but also bi-directional. Bi-directional means that a current picture is inter-predicted using the reference pictures which are temporally forward (future) and backward (past) pictures of the current picture.

For the anchor frame, it does not rely on any other pictures, and thus it is usually called intra frame. Intra frame reduces the spatial redundancy by performing intra-prediction between a current block and its neighboring blocks within the same current frame. Intra-prediction exploits the fact that pixels in a current block are often similar to the pixels in its neighboring blocks.

Inter-prediction and intra-prediction are two techniques widely used by different generations of video codecs, such as HEVC (described e.g. in JCT-VC, High Efficient Video Coding (HEVC), ITU-T Recommendation H.265 and ISO/IEC 23008-2, ITU-T and ISO/IEC JTC, 1 Apr. 2013), and VVC (described e.g. in JVET, Versatile Video Coding (VVC), ITU-T Recommendation H.266| ISO/IEC 23090-3, Apr. 2020). Both inter- and intra-predictions are performed at block basis.

After the introduction of the terms inter- and intra-prediction, in the following different frame types are explained based on their constitution of prediction blocks. Typically, three main frame types are defined in video coding: I, P, and B frames.
1. In I frames, all blocks are intra-predicted and have no dependency on other frames.
2. In P frames, additional uni-directional inter-prediction is allowed, where one or more temporal previous frames are used as their reference frames.
3. In B frames, additional bidirectional inter-prediction is allowed, where temporal both previous and future frames can be used as their reference frames.

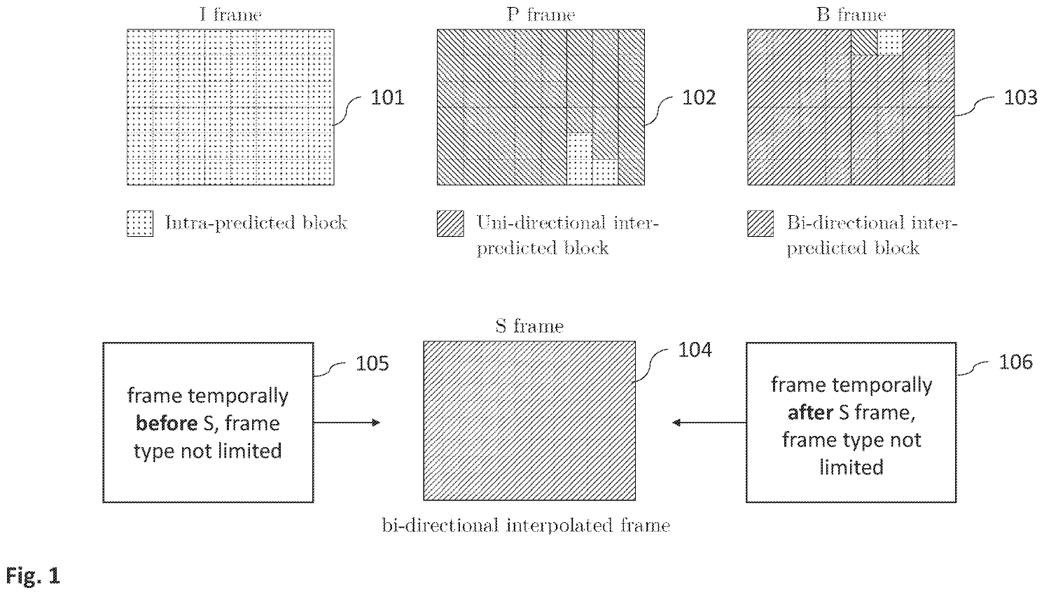

FIG. 1 illustrates the prediction block difference in I, P, and B frames. It is worth noting that P and B frames can also contain intra-predicted blocks. Regarding the compression ratio, usually an I frame 101 is least compressed as no temporal redundancy is exploited (highest bit cost). B frames 103 are best compressed as bi-prediction significantly improves its prediction accuracy. The bit cost for P frames 102 is between I and B frames.

In the present disclosure detailed further below, a new frame type S frame is introduced. As illustrated in FIG. 1, an S frame 104 is synthesized using a bi-directional interpolation module with two input frames 105 and 106, one frame 105 temporal wise before and the other 106 after. Unlike conventional codec's bi-directional inter-prediction, the interpolation of an S frame is performed at frame level instead of block level. This means that, contrary to B frames, no information on motion vector(s) nor may reference frame(s) index be required. Consequently, the bi-directional inter-prediction of S frames has a bit costs of zero.

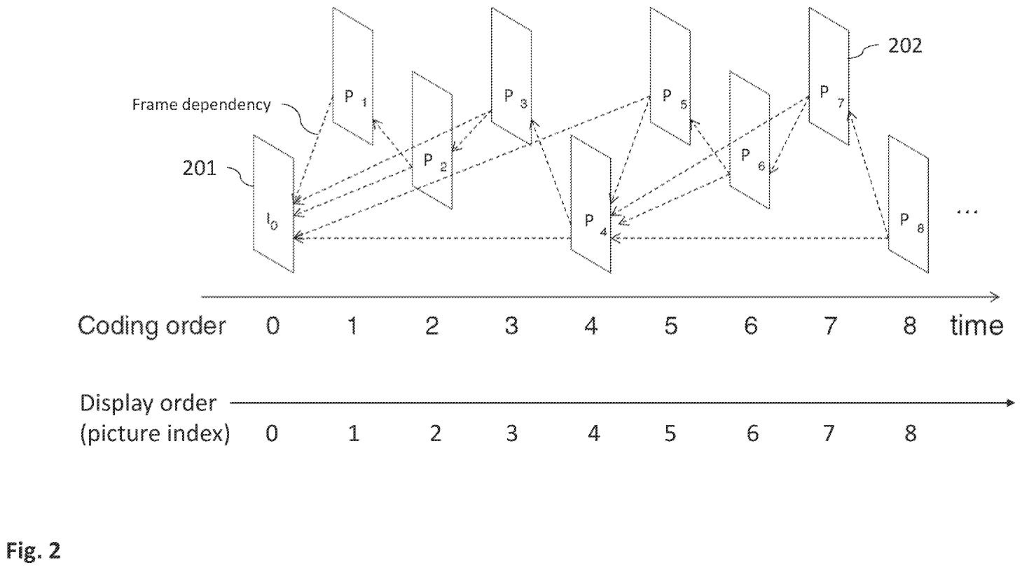

Since an I frame is the most expensive frame type in terms of bit cost, it might be assumed that an I frame should be chosen as less as possible in order to achieve the best compression efficiency. In some application scenarios, such as those requiring low delay and the content in a frame usually not changing, this is true. In FIG. 2, an example for a low delay configuration in HEVC is given, where the GOP includes one I frame 10 201 and the rest being P frames 202. The dashed arrows represent frame dependencies. For example, P frame P 3 points to P frame P2, and implies that frame P2 needs to be encoded/decoded before frame P3 as it needs frame P2. In a low delay configuration, the coding order and display order are the same, meaning the coding (decoding) order is I0-P1-P2-P3-P4-P5-P6-P7-P8. Therefore, the decoder just needs the previous (both in decoding and display order) frames to decode the current frame. No further frames from the future, i.e. frames that are temporally later than the current frame may be required.

However, an I frame might be necessary at other positions instead of the first frame in one of the following cases:
Random access: When the video is streamed, quite often people would like to seek for some specific picture in which they are interested. Therefore, a video needs to provide some random accessing points where it can instantly decode with no dependency on other previously decoded frames. However, if only one I frame is given at the beginning of a video sequence, the random access point probably would need to wait for the decoding of the I frame because of inter-prediction dependency. This would introduce a large latency. Large latency may be avoided by inserting an I frame in the video sequence to provide an additional random access point.
Scene changes: During content changes in a sequence, it's possible that a frame of an end scene (named as frame A) is followed by a frame having a completely new scene (named frame B). In such cases, an inter-prediction may not be performed well as these two frames have different content and, hence temporal redundancy cannot be exploited. A video encoder will often detect this situation and encode the frame B as an I-frame (i.e. an access point frame), so that all frames following the frame B have a refreshed reference picture (i.e. I frame). This is called scene change detection.
Error resiliency: Sending only differences for the majority of the video might not work well when the delivery media are imperfect. For example, packets may get lost, bits get flipped, and all sorts of other errors may happen in the real world. If in such cases an error or corruption occurs, said error will continue to propagate through the rest of the video stream until it concludes. Including additional I frames throughout a video sequence provides an error resiliency by providing a fresh good frame and clearing previous errors that may have been propagated otherwise.
Parallel processing: The encoding of a video usually costs a lot of time due to the high-complexity of the encoder. If each frame between two I frames could be inter-predicted, without referencing other frames outside these two I frames, then the entire video sequences could be segmented into several groups of consecutive pictures, where within each group of picture the first and the last frame is an I frame. Two consecutive groups might overlap with one I frame. The expense of encoding one more I frames compared to the benefit of parallel processing of the encoder is well accepted.

In view of the above cases, I frames are usually spread over a video sequence and the distance between two I frames determines the random access point granularity. In early video coding standards, such as MPEG-2, the length between two I frames are called group of pictures (GOP) size. The structure of a GOP is defined by two parameters M and N. The first parameter M represents the delay of encoding and decoding of frames, and the second parameter N represents the distance between two I frames.

For example, in a sequence with a frame pattern IBBBBPBBBBPBBBBI, the GOP size (N value) is equal to 15 (length between two I frames) and the encoding/decoding delay (M value) is 5 (length between I and P frames or length between two consecutive P Frames). For the second parameter M, the encoder or decoder cannot process the B frame directly following the I frames, unless the P frame five frames away are encoded/decoded before, so as to provide reference frames for the B frame inter-prediction.

The delay of encoding/decoding is an important determining parameter for the GOP size, rather than the distance between two I frames. The distance between two I frames is called I period in recent video coding standard such as HEVC or VVC. In addition, in recent video coding standard, B frames can also be considered as a reference frame and a hierarchical coding structure in a GOP is developed.

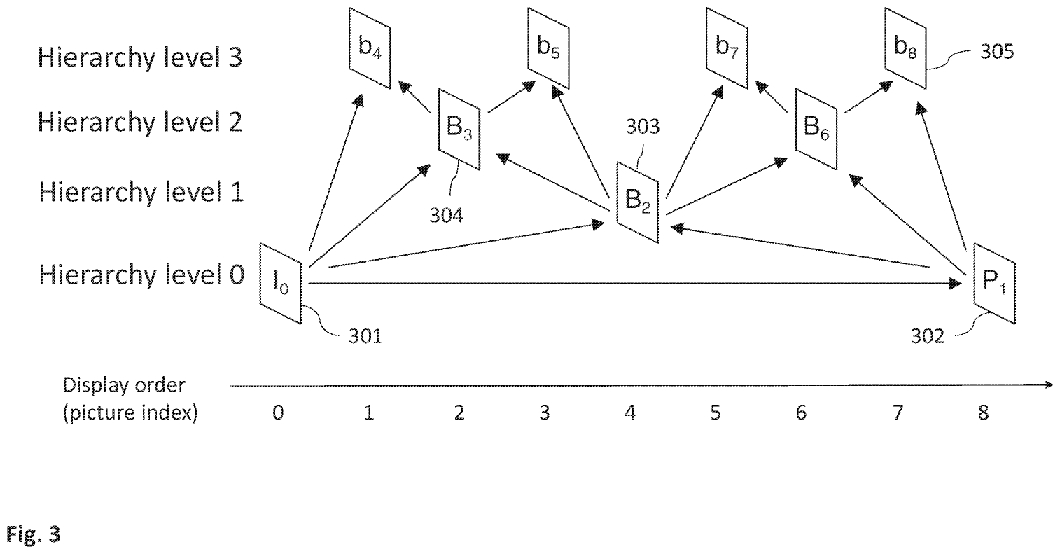

An example is depicted in FIG. 3, where a configuration example for random access is given. In a random access configuration, the coding order and display order of a GOP are different. The coding order is specified by the number along with the frame type in each frame box. If notated by the picture index in display order, the encoding order would be 0 (I₀), 8 (P₁), 4 (B₂), 2 (B₃), 1 (b₄), 3 (b₅), 6 (B₆), 5(b₇), 7(b₈). These pictures are classified into multiple hierarchy levels (H levels), for example, H0 to H3 in FIG. 3. In some embodiments, I frame I0 301 and P1 frame 301 are at H level 0. Likewise, B2 frame 303 is at H level 1, B frames B3 and B6 304, and b frames b4 to b8 305 are at H level 1, 2, and 3, respectively. The picture with a higher hierarchy level depends on the pictures with one or more lower hierarchy levels. Such a design can achieve a temporal scalable coding. When a system cannot process these frames in real time, it might discard frames with a higher H level. For example, dropping frames 305 (b4, b5, b7 and b8) would not affected other frames' coding, since there are no pictures depending on b4, b5, b7, b8. Dropping these frames are essentially equal to reduce the frame rate by half, as temporal wise half frames are discarded/dropped.

Conventionally, inter-frame interpolation is performed by motion compensation by exploiting motion information as mentioned before. Motion compensation derives a prediction block based on a most similar block from other already decoded frames. The movement of the current block and the reference blocks is represented by motion vectors, and the reference frame is indicated as a reference index. In case of bi-directional prediction, the final prediction result might be a weighted sum of two prediction results. The motion vectors and the reference indices are coded in the bitstream. Therefore, inter-prediction by motion compensation cost bits.

Frame Rate Up Conversion (FRUC) refers to a technique in which the frame interpolation may be performed without any bit cost. Taking the example shown in FIG. 3, when pictures (frames) on lower hierarchy levels 0, 1, 2 are all decoded, FRUC would evenly interpolate frames 305 (b4, b5, b7, b8) instead of decoding them. This essentially decreases the frame rate by two, if b4, b5, b7 and b8 at H-level 3 are skipped already in the encoder. Even if pictures b4, b5, b7, and b8 at the highest H level 3 have been encoded in the bitstream, the decoder might still perform FRUC for frames b4 to b8 instead of decoding them. For example, when the decoder cannot achieve real time decoding, FRUC can employed for interpolating frames b3 to b8 to reduce the load of the decoder. However, without using motion vectors and reference indices, such an interpolated frame using FRUC usually leads to a poor quality.

In recent years, neural networks (NN) are designed to learn the process of frame interpolation. For example, in H. Lee et al., “AdaCoF: Adaptive Collaboration of Flows for Video Frame Interpolation”, CVPR 2020, describes the neural network learning the frame interpolation from a dataset, consisting of tens of thousands of frame triplets. Each frame triplet consists of three consecutive frames, indexed as 0, 1, and 2. The NN performs frame interpolation using frames with index 0 and 2, and generates a synthesized frame for frame 1. The loss function is defined based on the quality loss between the synthesized frame and original frame 1. By minimizing the loss function during training, the interpolated frame has achieved reasonable image quality after about 50 epochs.

Both approaches of frame-interpolation using FRUC and the neural network are bi-directional, i.e. they use two frames, one backward and one forward (temporal), to interpolate the frame in the middle at zero bit cost.

As may be discerned from the above discussion, the choice of the best suitable frame types across the video sequence is crucial for the overall coding (and decoding) efficiency. The problem of choosing the best suitable frames may be illustrated as follows: introducing, for example, I frames at positions of a scene change (i.e. decreasing N for rapid scene change) mitigates errors as the number of random access points is increased, at the expense of increased bit costs as result of the poor compression. In turn, increasing the intra period (N value) in case of infrequent scene changes reduces the number of least compressed I frames, at the expense of reducing the number of random access points. Similarly, increasing the GOP size (M value), and hence the number of B frames within a GOP can save bits, at the expense of increasing the encoder/decoder delay to such an extent which may not be tolerable in some applications.

Therefore, a solution of the above problem is needed that leverages the selection of the right frame types to improve coding efficiency without further increasing the encoder/decoder delay (M) and intra period (N).

The present disclosure addresses the above problem in that a new frame type, i.e. a synthesized frame (S frame), is introduced. As further discussed below, the use of S frames allows to adaptively insert one or more S frames into the GOP structure or to replace a frame of a fixed GOP structure with an S frame. It is noted that he terms “insert” and “replace” should not be interpreted in a literal manner, but rather have a particular meaning within the context of GOP structures being adaptive or fixed. This will be explained in more detail below.

Synthesized frames are not encoded, but instead generated based on reference frames using a frame interpolation module and hence encounter no bit cost. Rather, an indication of a position is included into a bitstream (or a portion thereof) while the reference frames are encoded. A synthesized frames may be also referred to as synthetic frame. A frame may also refer to a picture or a frame of a picture or picture frame.

The adaptive insertion is done according to a criterion and a maximum look ahead constant. Synthetic frames are inserted only into the GOP, if the criterion is met, e.g. only if a minimum threshold in terms of an image quality metric is reached between the original frame and synthetic frame. This makes the insertion of S frames potentially adaptive to the video content. The maximum look ahead constant sets a limit to the amount of neighboring S frames, i.e. the look ahead value equals the maximum allowed distance between two coded frames (B, P or I).

In this way, the GOP size is potentially adaptive as it depends on the number of inserted or replaced S frames. The GOP may be larger or smaller, with the encoder/decoder delay being dependent on the maximum look ahead value, and hence is limited. Compared to enforcing an upper limit on the M and N values to limit the encoder/decoder delay for existing adaptive GOP size techniques, the present disclosure still allows saving bits by further inserting S frames which are not encoded. Therefore, bits can still be saved by replacing B frames with S frames, even if the maximum M value of the GOP (the distance between P or I frames) is chosen to be small. Compared to FRUC, the benefit of skipping encoding of frames and interpolating them on the decoder is kept. However, it eliminates the disadvantages due to lowering the frame rate, e.g. by dropping frames that are difficult to interpolate. The method of the present disclosure is orthogonal to the existing adaptive GOP techniques as they can be used in conjunction.

An input frame refers to a frame which is input to the encoding. It may be an original frame such as an uncompressed frame output by a camera, e.g. a frame that is not processed, for example, by encoding or decoding or the like. In other words, input frames may correspond to raw (possibly demosaicked) video data. Further, a frame may be also referred to as picture or picture frame or image.

According to the present disclosure, not all of said input frames may need to be encoded into the bitstream or a bitstream portion. For that purpose, a synthesized frame is generated at a predetermined (e.g. a first) position instead of a predetermined (e.g. a first) input frame, the synthetization being based on two or more input frames. A synthesized frame is obtained by interpolation from one or more other frames. The one or more other frames may be, e.g., frames which are encoded into the bitstream (their content is encoded into the bitstream) or other synthesized frames.

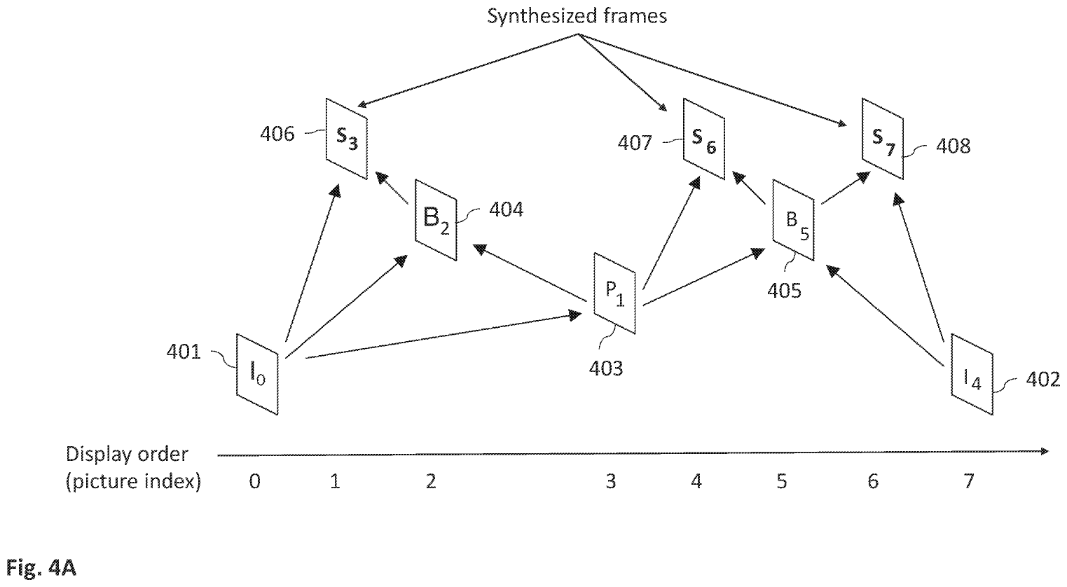

This is illustrated in FIG. 4A showing the generation of S frame 406 at a first position with index idx=1 from two frames 10 401 and B2 404 having positions at index idx=0 and idx=2, respectively (in the display order). It is noted that position refers to an instance in time with respect to a display order. Display order means the order in which frames of the video sequence are e.g. displayed on a screen or the like. In other words, the display order commonly follows a time order in which the frames were captured or created, i.e. the order of frames in the input sequence. A position in time is referred to as picture index. The synthesized frame (S frame) may be generated by interpolating the synthesized frame based on one or more input frames preceding the synthesized frame and on one or more input frames succeeding the synthesized frame in a display order (i.e. picture index). Accordingly, the generated S frame may entail time correlation from preceding and succeeding frames, and thus lead to a more accurate interpolation and thus closer match with the original frame. It is noted that the S frame may be interpolated directly from the input frames at the encoder. At the decoder, however, the input (uncoded) frames are not available. Thus, the S frame may be interpolated at both encoder and decoder from the reconstructed input frame(s), i.e. input frames, which are encoded as I, P, or B frames and then reconstructed.

Moreover, the one or more frames preceding and/or succeeding the S frame in display order may be neighboring frames of the S frame. Neighboring means that the respective preceding and succeeding frames are temporally located (w.r.t. display order) directly before or after the S frame. Also, the number (i.e. the amount) of the one or more neighboring frames may be any number ranging from 1 to 64. It is noted that the range [1 to 64] depends on the current technology and it is understood that, with progressing CODEC technology, said interval may be extended.

Accordingly, the S frame may be generated via simple bi-directional interpolation or higher order schemes by including an increased number of preceding and succeeding frames, which may ne neighboring the S frame. As a result, an S frame may be generated entailing time correlation from preceding and/or succeeding frames at various degree. Hence, the inter-frame correlation may be tunable e.g. depending on the content of the S frame and/or content of the preceding and succeeding frames.

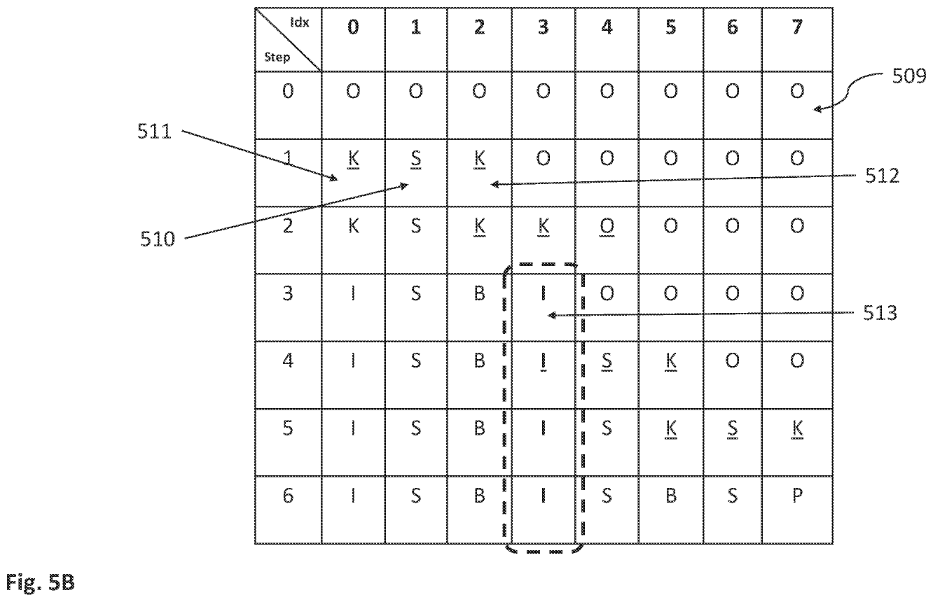

In the example of FIG. 1, the S frame 104 is generated by (simple) bi-directional interpolation using one input frame 105 preceding and one input frame 106 succeeding the S frame. Thus, in this case, only one frame 105 and 106 is used, both of which are direct neighbors of S frame 104. In turn, FIG. 7 illustrates a case where a S frame at index idx=4 (dashed box) is generated from frames 701 and 702 at positions idx=0 and idx=8, and hence are not direct neighboring the S frame (case in FIG. 7 for 1” tried GOP). Similar applies for the 2^{nd} tried GOP in FIG. 7. For the 3^{rd} tried GOP in FIG. 4, frames 701 and 704 are again direct neighbors of S frame at position idx=1.

The S frame may be generated on the encoder side, for example, by a neural network (NN), The NN may be any network that is trained by training data as part of a learning process. Likewise, a NN may be used for generating the S frame on the decoder side. Accordingly, the generating of the bitstream may be performed with a trained network optimized for frame interpolation. Hence, the interpolation and thus determination of whether or not an S frame should be generated may be performed accurately. This may lead to a larger reduction of rate of the coded bitstream.

According to an aspect, frames in a video sequence are adaptively selected on top of an existing video CODEC, and the selected frames are not coded using the existing video CODEC, but are replaced with synthesized frames generated from a neural network trained for frame interpolation. Also, the frames synthesized by frame interpolation from the neural network does not cost bit. Further, the adaptively selecting frame process is based on synthetic frames generated from the same neural network using the original frames (i.e. input frames) in a video sequence. In another aspect, the adaptively selecting frame process takes a criterion as an input, from which the frames are determined to be replaced or not. The criterion is compared against to one or more features of one or more synthesized frames using the original frames in a video sequence. In other words, based on a criterion such as the quality measure for the synthesized frame, it is determined whether or not an S frame is to be generated.

At this stage, the first input frame at said first position is not processed (e.g. encoded) and may not be needed. This is because, a quality measure for the synthesized frame is determined beforehand. As quality measure (QM) any of peak signal to noise ratio, PSNR, resolution, bit depth, or a perceptual quality metric may be suitable. The perceptual quality metric may be a structural similarity index measure (SSIM). Accordingly, different kinds of known quality measures may be used for the synthesized frame. A particular quality metric may be selected based on an application. Using resolution and/or bit depth may be simple and thus efficient as they do not require any additional computation effort. On the other hand, PSNR is a widely used objective metric, whereas a perceptual metric (e.g. an estimator of subjective opinion score) may further reduce bitrate without compromising user experience. The quality measures are not limited to those listed above. Other kind of QMs may be used in addition and/or may be combined. In the following, the PSNR is used as mere example to illustrate aspects of the processing of the present disclosure.

Using PSNR, the QM for the synthesized frame is determined by calculating the PSNR of the synthesized frame. Whether or not the first input frame (e.g. at position idx=1 in FIG. 4A) is encoded, depends on the QM. In some embodiments, when the quality measure fulfills a predetermined condition, an indication of said first position is included into a bitstream portion. The bitstream portion may be a first and/or a second portion of a bitstream.

In turn, when the quality measure does not fulfill the predetermined condition, content of said first input frame is encoded into the bitstream portion. For example, the predetermined condition may be PSNR difference between the S frame and the first input frame being larger than a predefined threshold. In this case, a PSNR of the first input frame is calculated as well. Alternatively, the PSNR may be compared directly with the predefined threshold, i.e. said threshold is fixed at least during the processing. Another option for the QM is using a PSNR of an input frame that is different from the first input frame. In other words, the PSNR of the S frame generated at the first position is compared with the PSNR of a frame at a position different from the first position. The term content refers to video data of the first input frame. In the following, the terms “content” and “coded frame” are used synonymously, and means that the (en) coding of a (input) frame refers to coding the respective video data of the frame.

In the example, if the PSNR of the S frame is of sufficient quality (i.e. QM fulfills the criteria on quality), an indication of the first position is included into the bitstream portion. Said indication may be any suitable indicator, such as a simple FLAG (e.g. binary flag with “1” indicating generate S frame at first position and “0” indicating not generating S frame at first position). In addition or alternatively, the indication may be index of the first position (i.e. the picture index). Including the indication means, for example, including the indication into a header of the bitstream or the bitstream portion. Alternatively, the indication may be encoded into the bitstream portion. In this case, a content of the first input frame is not encoded into the bitstream portion. Accordingly, the bit costs for the generated bitstream is reduced, improving the compression without increase of encoding latency.

In turn, when the PSNR of the S frame is not of sufficient quality (i.e. QM fulfills the criteria on quality), the content of the first input frame is encoded into the bitstream portion. In this case, the first input frame can be coded as any of an intra-predicted frame I, an unidirectional inter-prediction frame P, and a bidirectional inter-prediction frame B, corresponding respectively to frame types I, P, and B. The different kind of frame types are shown in FIG. 1, with I frame 101, P frame 102, and B frame 103. Accordingly, an input frame to be coded may be assigned any of frame types I, B, or P, which have different bit cost. Therefore, the bit costs may be optimized based on the assigned frame type.

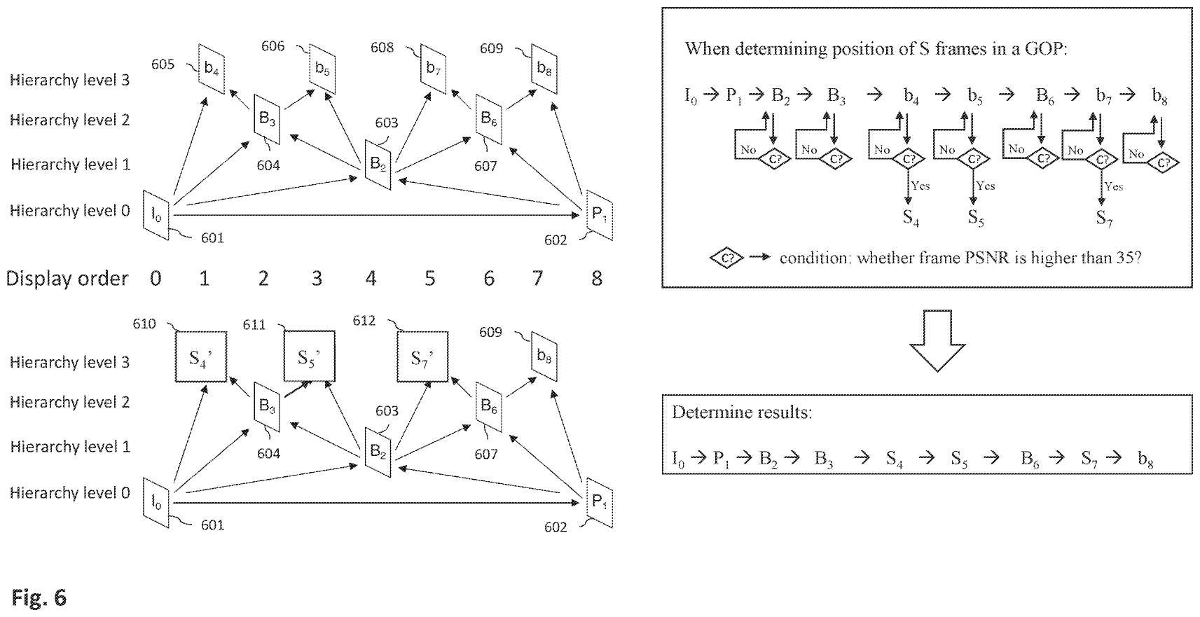

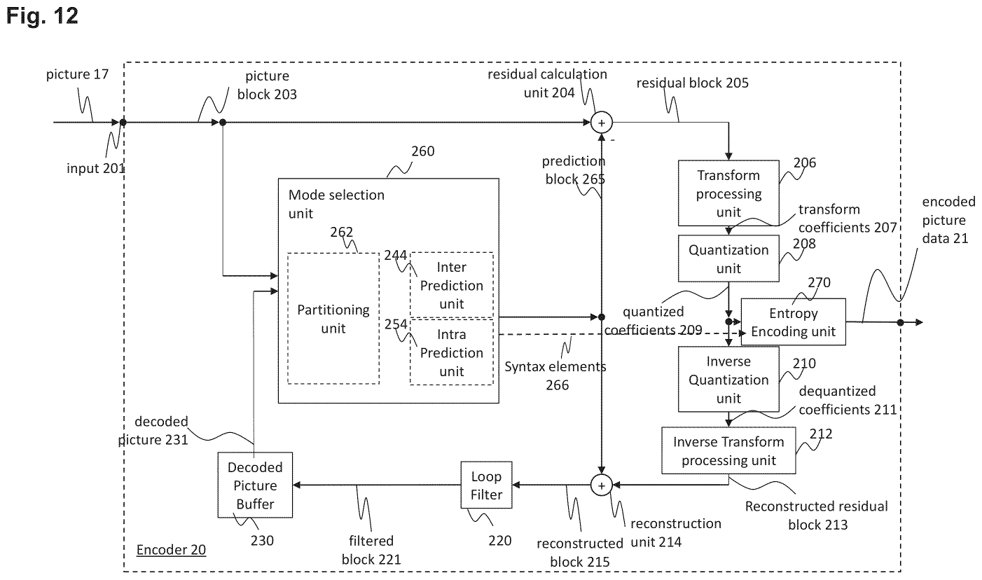

The above described generation of the bitstream may be realized in a hardware implementation. FIG. 8 shows an exemplary implementation of an apparatus 800 which has a processing circuitry 810 for performing various kind of processing steps by corresponding modules. Generating module 812 is configured to generate a synthesized frame at a first position of a first input frame, based on two or more input frames. Then, a quality measure QM is determined for the S frame via determining module 814. Based on the determined QM, including module 816 checks whether or not the quality measure fulfills a predetermined condition as discussed further above. In one exemplary implementation, module 816 is configured to include an indication of the first position of the respective first input frame into a bitstream portion, if the QM fulfills the predetermined condition, such as a PSNR of the S frame being sufficiently high. In turn, when the QM does not fulfill the predetermined condition, encoding module 818 encodes the content of the first input frame into the bitstream portion. The (en) coding processing may be performed, for example, by encoder 20 shown in FIG. 12. It is noted that the check of the QM quality may be performed by including module 816, in which case including module 816 signals to encoding module 818 at least, as a result of the QM check, that the content needs to be encoded (signaling not explicitly shown in FIG. 8).

With the basic processing performed on the encoding side, the decoding side takes the generated bitstream as input, and then generates frames of the video sequence from the bitstream. This may be performed by decoding the content of two or more frames of the video sequence from the bitstream portion. Similar to the encoding side, the term “content” refers here to video of a decoded frame. In other words, the terms “content”, “decoded content”, and “decoded frame” are used synonymously. Further, the bitstream portion is parsed for an indication of a first position. The indication may be a FLAG indicating that a S frame is generated or not at said position. For example, a FLAG “1” may indicate generating the S frame, whereas “0” indicates no S frame generation. Alternatively, the indication may be the position in terms of the picture index of an S frame generated at said position.

The two or more decoded frames may be any of an intra-predicted frame I, an unidirectional inter-prediction frame P, and a bidirectional inter-prediction frame B, corresponding to frame types I, P, and B. With two decoded frames along with the parsed indication, a synthesized frame is generated, based on the parsed indication, as a frame of the video sequence, based on two or more previously generated frames. Accordingly, the decoder is able to decode content and position indication from a lightweight bitstream. Thus, the generating of frames for a GOP may be accelerated.

The previous generated frames may include both decoded frames and S frames, with said S frames being generated before. In a typical situation, at least two decoded frames are available initially, which are then used to generate an S frame. This means that at the encoding side there are now two decoded frames and one S frame corresponding to frames of the video sequence. In this example step, any two of the S frame and two decoded frames may be used to generate a next S frame. Assuming for the purpose of demonstration that bi-directional prediction is performed, the next S frame is generated from frame pairs (D,D); (D,S), (S,D), and (S,S), with “D” referring to a decoded frame and “S” to an S frame. When the previously generated frames are more than two, then the S frame is generated by triplets, quadruples, etc. of D and S frames. For example, in the triplet case, such triple pairs could be (DDD), (DDS), (DSD), (SDD), (SDS), and (SSS).

Similar to the processing on the encoding side, the synthesized frame may be generated by interpolating the synthesized frame based on one or more previously generated frames preceding the synthesized frame and on one or more previously generated frames succeeding the synthesized frame in a display order. Accordingly, the generated S frame may entail time correlation from preceding and succeeding frames and thus lead to a more accurate interpolation and thus closer match with the original frame.

Also, the one or more preceding and/or succeeding already generated frames in display order may be neighboring frames of the synthesized frame, respectively. Moreover, an amount (i.e. a number) of one or more neighboring frames may be any of a number ranging from 1 to 64. As mentioned before, the range may evolve with advanced CODEC technology. The S frame generation using two or more (neighboring) preceding/succeeding frames may be illustrated for a frame S to be generated for the following sequence: 1. triplet (DSD), (SSD), (DSS), and (SSS). 2. Quadruple (DSDD), (DSSD), (DSDS), (DSSS), (SSDD), (SSSD), (SSDS), (SSSS) etc. Thus, an S frame may be generated in a flexible manner, exploiting previously generated frames at varying number (both preceding and succeeding frames) as well as the degree of being neighboring to the S frame to be generated. Accordingly, the frames of the vide sequence may be generated accounting for inter-frame correlations at different degree.

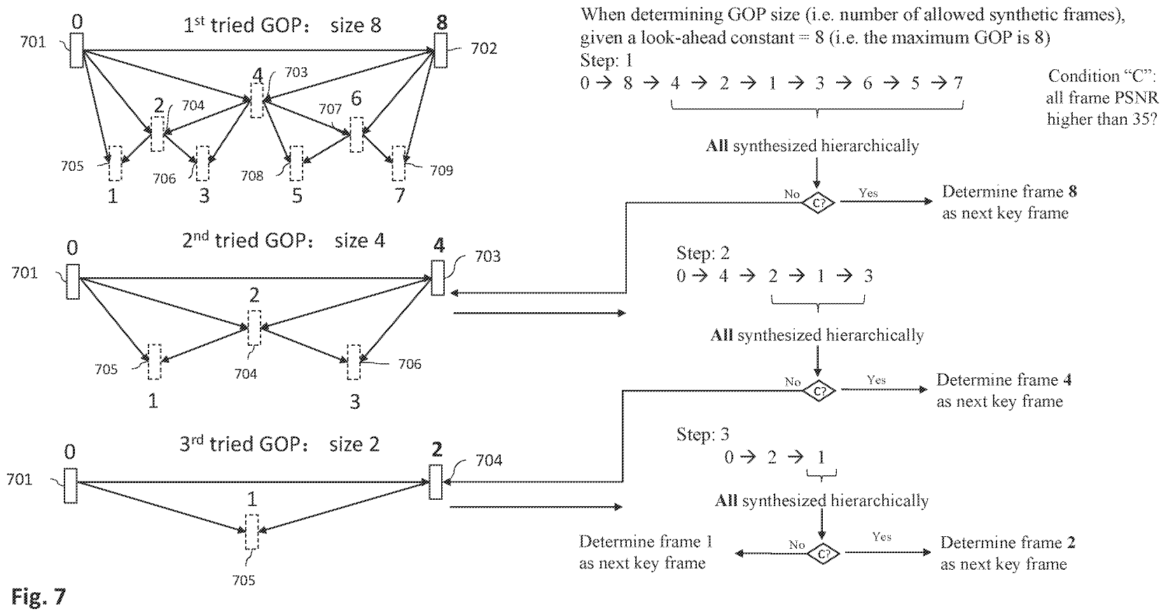

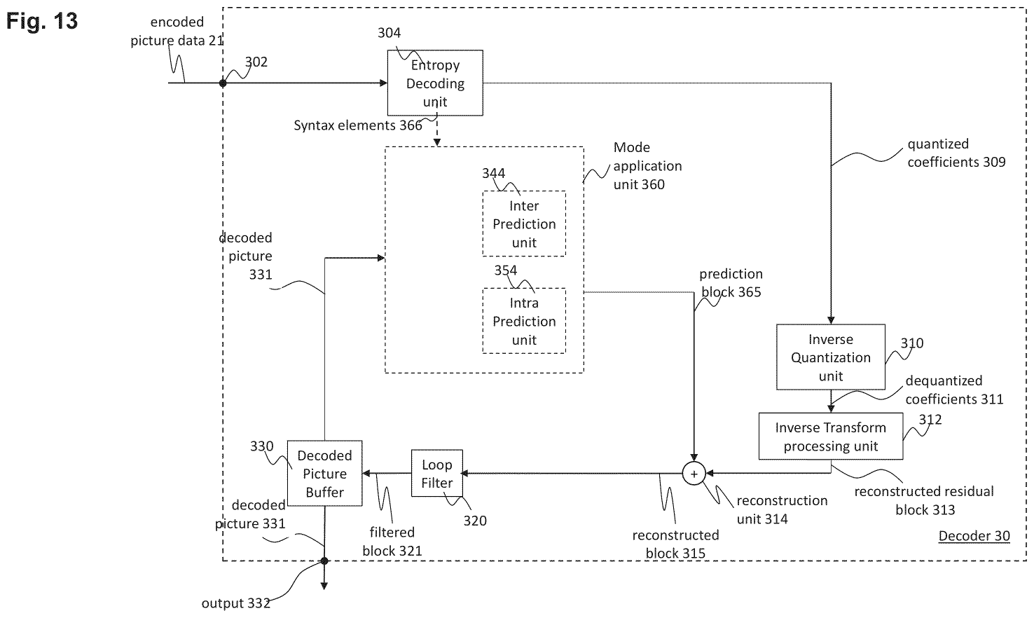

The above described frame generation may be realized in a hardware implementation. FIG. 9 shows an exemplary implementation of an apparatus 900 which has a processing circuitry 910 for performing various kind of processing steps by corresponding modules. Decoding module 912 is configured to decode from a bitstream portion content of two or more frames of the video sequence. The decoding processing may be performed, for example, by decoder 30 shown in FIG. 13. In order to know if and where S frames should be generated, parsing module 914 parses the bitstream portion for an indication of a first position. Then, generating module 916 generates, based on the parsed indication, the S frame as a frame of the video sequence at the first position based on the two or more previously generated frames.

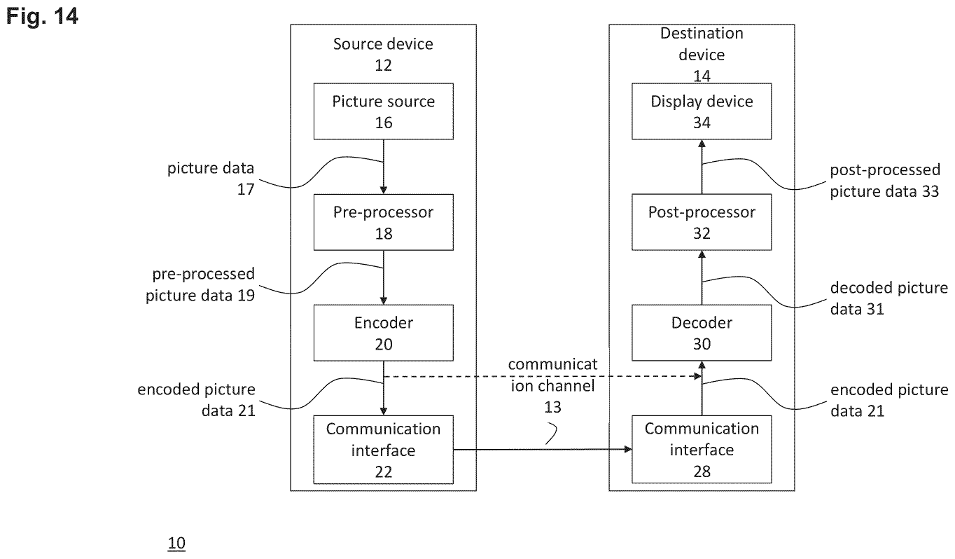

The encoding and decoding processing may be performed by separate apparatuses such as encoder 20 in FIG. 12 and decoder 30 in FIG. 13. Alternatively, the encoder 20 and decoder 30 may be combined into an encoding-decoding system shown in FIGS. 13 and 14, respectively. Further details on these apparatuses and systems and their respective processing is provided at the end of discussing the following embodiments of the present disclosure.

In the following embodiments, preferred implementations of the present disclosure are discussed.

### Embodiment 1

In the following, an example is discussed with reference to FIGS. 4A and 4B. FIG. 4A shows a sequence of frames of a GOP having particular frame types after the end of the processing. These frames types include I types (frames 401 and 401), P type (frame 403), B types (frames 404 and 405), and S types (frames 406 to 408). The processing is illustrated in the table of FIG. 4B, with 8 frames in the picture buffer of the encoder, and are marked at each step of the processing by underlining. Frames that have not yet been processed, are denoted as O (indicating original frames), synthetic frames S and coded frames K. Coded frames may be any of I, B or P frame corresponding to frame types, respectively. Hence, O frames 409 in FIG. 4B correspond to input frames of the video sequence.

In the example discussed, a synthesized frame 410 is generated from two input frames 411 and 412 (O frames). It is noted that there may be more than two input frames. Further, the frames shown in FIG. 4A belong to a Group of Pictures, GOP, which includes the S frame to be generated. Such S frame may, for example, be frame S3 406. In this example, PSNR is used as the quality measure QM. Accordingly, the first position is signaled in the bitstream with a simple indication. This reduces the signaling overhead.

In the example of FIG. 4B, lets it is assumed that a maximum encoder/decoder delay (M value) of 4 may be tolerable for a use case, and I frames shall be inserted at least every 8 frames. The encoder may be configured to use the following internally fixed GOP structure: IBPBI, which translates into an encoding/decoding delay of M=2 and a GOP size of N=4 (GOP period). To ensure a maximum encoder/decoder delay of 4, the look ahead constant is set to 2 (i.e. look ahead constant=maximum delay/M of fixed GOP=4/2=2, with “/” denoting the division operation). The criterion in this example enforces a minimum PSNR of 35. The look ahead constant may be predefined and determines a maximum number of S frames that can be generated for the GOP. Accordingly, the number of synthesized frames may be adapted within a range of the look ahead constant. Therefore, the S frame determination may be performed in a flexible manner, enabling a dynamic adaptivity of the GOP.

According to an aspect, the adaptively selecting frame process takes a constant number N of look-ahead frames as an input. The constant number of look-ahead frames determines the maximum number frames that could be replaced by synthetic frames over a video sequence.

The original frames are ordered according to the display order, and have a picture index (i.e. positions) idx=0 to idx=7.

According to the look ahead value of 2 and with eight original frame O in the buffer (step 0), the process starts in step 1 by considering the first three frames and adding them to the buffer. The frame at index idx=0 is set to be a coded frame. In some embodiments, the frame with idx=0 is assigned the frame type I since it is the first frame in the frame sequence of the GOP. In other words, I frame 401 in FIG. 4A and 411 in FIG. 4B is a starting frame of the GOP and is (en)coded. The GOP has also an ending frame which is also a coded frame. In FIG. 4A, the ending frame is frame 402. It is noted that, in the following discussion, the indicated index is in display order. In FIG. 4A, the respective I frame is frame 10 401. Accordingly, the frames to be encoded are determined based on a GOP pattern, allowing for tuning the sequence of coded frames within a predefined GOP structure. This may be beneficial especially for applications which may require fixed GOP size.

To perform the bi-directional interpolation, the first and last frame in the buffer (idx=0 and idx=2) are used to interpolate a frame in the middle (idx=1). As the synthesized frame meets the criterion it is assigned an S type, which corresponds to S3 frame 406 in FIG. 4A. This means that the indication of the first position, namely picture index idx=1 is included into the bitstream portion. Therefore, the indication indicates that an S frame is to be generated at the position of the GOP as indicated by the indication. As a result, the respective input frame (i.e. original frame) at position idx=1 is not encoded, i.e. its content (video) is not encoded.

The frame type of the frame at position idx=2, which is different from the I type of the starting frame of I type of the GOP, still needs to be specified. The assignment of one of frame types P and B is performed in accordance with a predefined GOP pattern of frame types. In this example, the GOP pattern is IBP, whereby the type at the very beginning of said pattern is an I type as it refers to the access point of the respective GOP. As noted earlier, an access point refers to a reference frame and is the first frame of a GOP.

The frame at idx=2 is assigned a coded frame type (B, P) to satisfy the look ahead constant of 2. Therefore, frame 412 in FIG. 4B is coded, i.e. the respective original frame at idx=2. In step 2, the last coded frame (idx=2) is kept in the buffer and the next two frames at idx=3 and idx=4 are added, with the frame at idx=3 being in the middle of idx=2 and idx=4 frames. Therefore, the frame at index idx=3 is synthesized based on frames idx=2 and idx=4 and is assigned a coded frame type since it does not meet the criterion. This means that the quality measure PSNR of the S frame at idx=3 is not sufficient, and hence is to be coded into the bitstream portion.

At this point, three key frames have been already determined, which equals the GOP size of 4 having the fixed GOP pattern (IBP). Accordingly, in step 3 each coded frame K within the GOP structure KSKK is assigned its appropriate type according to the defined GOP pattern. With reference to the GOP pattern IBP, S frames are skipped in this process, resulting in an effective increase of the final GOP because it includes an additional S frame. Hence, the final sequence for the first GOP is ISBP (as opposed to IBP). In FIG. 4A, the respective B and P frame is frame B2 404 and frame P1 403, respectively. The frames 10 401, B2 404, and P1 401 in FIG. 4A can now be coded (i.e. their video content) into the bitstream portion in the coding order (I-P-B), and sent to the decoder. S frame S3 406 is not encoded.

For each coded frame, the indication of the positions of the S frames includes positions of the coded frames. In one example, the indication may be the distance to the next coded frame, which is signaled in the frame header. Alternatively, the position of the coded frames may be signaled in the frame header. Further, the position of one or more frames and the distances may be signaled in the frame header. The distance may be a difference between indices of respective coded frames.

Next, in step 4, frames with idx=3 and idx=4 are kept in the buffer and frame idx=5 is added to the buffer. The above process of interpolation in accordance with the encoding/decoding delay and the GOP pattern is now repeated for frame idx=4 to idx=7, until one ends up with the following total GOP sequence, with inserted S frames: ISBPSBSI. Therefore, by generating a bitstream according to a predefined look ahead constant and a GOP pattern, the GOP may be adaptively enlarged. In the example of FIG. 4B, the remaining frames SBSI of the GOP are frames S6 407, B5 406, S7 408, and 14 402, respectively. However, only the input frames of frame type I, B, and P are encoded into the bitstream portion.

With the bitstream being generated by the encoding side described before, the decoding side receives the bitstream which includes coded frames as well as indications of a first position at which a synthesized frame is to be generated. In some embodiments, the indication indicates a first position within a GOP where the S frame is generated. Accordingly, the decoder knows where to generate a synthesized frame within the GOP.

With reference to the previous example, the decoder receives the following encoded bitstream (IBPBI), which can be decoded in the usual manner. Thus, the GOP includes two or more decoded frames comprising a starting frame and an ending frame. The starting frame has a frame type I and the ending frame a frame type B or P, respectively. The decoded two or more frames may be put into a decoded frame buffer in case one or more frames of the GOP depend on the frame at the first position. Accordingly, decoded frames are available in case of frame dependencies. Thus, S frames which may depend on decoded frames may be generated accurately at higher hierarchy level while preserving frame dependencies. In order that decoder knows if and where to generate S frames into the GOP, determines based on the parsed indication a position difference between the two decoded frames, which have successive positions in display order.

For each decoded GOP, the decoder checks for gaps between every pair of consecutive coded frames, as the signaled indication of the first position includes positions of the decoded two or more frames. Accordingly, the decoder knows the positions of decoded frames within the GOP. Based on the indication, the decoder checks gaps in position between successive decoded frames based on position differences and/or positions of the respective coded frames. In other words, the signaled indication enables the decoding side to indirectly determine the first position via the signaled position(s) or position difference(s) between consecutive decoded frames. In other words, based on the position difference, the decoder determines a number of S frames generated between the two decoded frames.

The decoder then fills the gap at the respective positions by generating S frames in decoding order between successive coded frames of the GOP based on the position difference, yielding the following final GOP structure: ISBPSBSI of the video sequence. This structure fulfills all predefined conditions, i.e. N=7, M=3 for the first GOP, and M=4 for the second GOP of this GOP sequence.

Herein, the encoder/decoding delay (i.e. M value) can change depending on the number of inserted S frames, and hence the GOP structure can be dynamically changed as well. However, the maximum encoding/decoding delay is confined by the original encoding pattern IBPBI and the given look-ahead constant. Given the maximum look ahead constant equal to 2 in the above example, the maximum number of permissible S frame insertions would be ISBSPSBSI.

### Embodiment 2

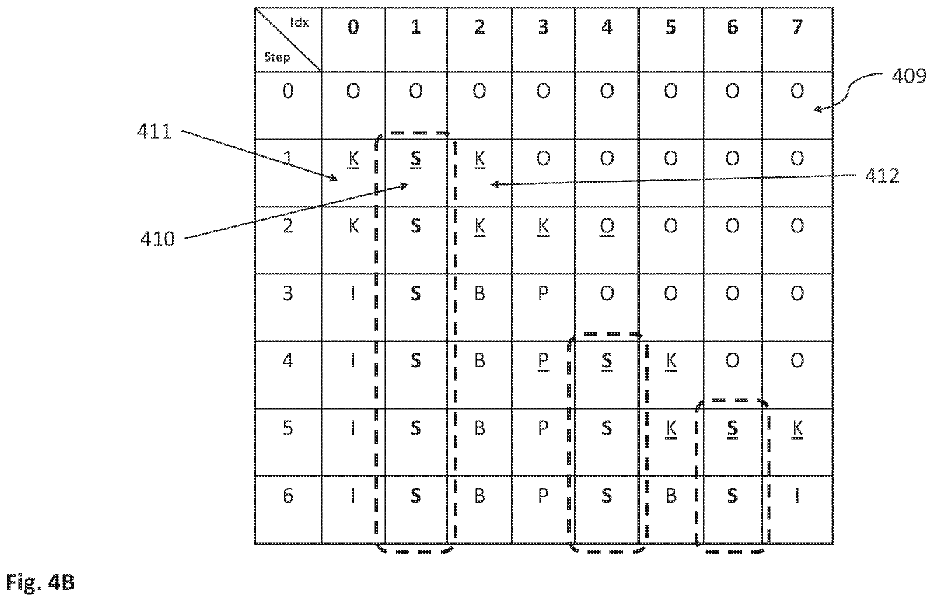

Instead of combining a fixed GOP pattern (e.g. IBPBI) with the adaptive generation of S frames as discussed in embodiment 1, embodiment 2 relates to how to adaptively generate S frames within an already adaptive GOP structure. To this end, the previous example is modified so as to use the adaptive GOP method proposed by B. Zatt et al. instead of the fixed IBPBI pattern, as illustrated in FIG. 5A. As may be discerned, the final GOP sequence after the processing is ISBISBSP, including frames Io 501 and Il 503, frame P4 502, frames B2 5054 and B5 505, and frames S3 506, S6 507, and S7 508. The respective GOP structure is IBIBP, with 10, Il, P4, B2, and B5 being coded.

To ensure an encoder/decoder delay of 4, the size of the interval of inserted P frames is changed in the example of FIG. 5A from 8 to 2 compared to the implementation by B. Zatt et al. which does not utilize synthesized frames as the present disclosure does. The process to generate a bitstream having such a GOP structure of coded frames is illustrated in the table of FIG. 5B, and is performed in a similar manner as to the one of embodiment 1 (table of FIG. 4B).

The difference is that now in step 3 the frame types are assigned to the frames, based on the policy in the work of B. Zatt et al. Without employing the policy of B Zatt et al., the following structure IBP is produced, since the algorithm detects a scene change at index idx=3. In contrast, embodiment 2 of the present disclosure, the scene change is detected based on the frames of the GOP, and the frame at which the scene change occurs is assigned instead a I frame. This yields a GOP structure of IBI, with the respective frame being Il 503 in FIG. 5A. the respective frame assigned frame type I is encoded. Accordingly, frame types within the GOP may be adapted depending on the degree of scene change. Hence, the bit costs may be optimized in account of the degree and occurrence of scene changes.

This is illustrated in the table of FIG. 5B, where a frame type I is assigned to an input frame 513 (i.e. original frame O) at index idx=3 in case a scene change is detected at this instance. Hence, the intra period, i.e. the distance between successive I frames is temporarily lowered. Otherwise, the processing follows the same procedure as already described in embodiment 1. The respective full GOP sequence ISBISBSP is illustrated in FIG. 5A, with frames I0 501-S3 506-B2 504-Il 503-S6 507-B5 505-S7 508-P4 502, respectively. As mentioned before, only coded frames 10, B2, Il, B5, and P4 corresponding to the GOP pattern IBIBP are encoded into the bitstream portion.

Since the I frame is also encoded into the bitstream portion (i.e. its video content), the two or more decoded frames of the GOP include one or more decoded frames of frame type I. Accordingly, the frames of the GOP include frames of frame type I between the starting frame and the ending frame, representing access points for video content at which a scene change occurs. In FIG. 5A, these frames are 10 501 and Il 503, with frame I1 being the frame generated from the bitstream by the processing on the decoding side. As FIG. 5A illustrates, the I frames 10 and Il have positions in display order with index idx=0 for frame 501 and idx=3 for frame 503. Both frames are between starting frame 10 and ending frame 502 of the GOP. The actual generation of the frames of the GOP follow the same processing as discussed before.

### Embodiment 3

Compared to embodiment 1 and 2 where the GOP structure is changed after the generating of S frames, in embodiment 3 the coding structure in a GOP may not be changed, but rather the frames in a given GOP (i.e. the GOP is fixed) are selectively replaced with the synthetic frame. It is noted that the term “replace” is not understood literally. Rather, the term means that, for a fixed GOP, an input frame at a first portion may not be encoded, but rather an S frame is generated.

Therefore, in embodiment 2, a look-ahead constant may not be needed as input, as it is assumed to be the same as the considered GOP size. In particular, the first input frame (i.e. a first original O frame) pertains to a GOP of a predefined GOP structure, which is fixed.

To recall, in embodiments 1 and 2 discussed before, the synthesized frames are generated using original frames (i.e. input frames), after positions of S frames are determined, and this information is used during encoding. The processing in embodiment 3 may not decouple the determination process and encoding process. Rather, it is determined which frame in a GOP shall be replaced during the encoding process, and the determined (one or more) frames are synthesized using the previously coded frames instead of original frames (i.e. input frames).

Again, the quality measure (e.g. PSNR) is used to determine whether or not a first input frame is to be encoded. In an implementation, when the QM does not fulfill the predetermine condition, the content of a first input frame is encoded into the bitstream portion. The frame type is assigned to the first input frame in accordance to a GOP pattern of frame types, which is pre-configured for the respective GOP. In turn, when the QM fulfills the predetermined condition, the content of the first input picture is not encoded into the bitstream portion.

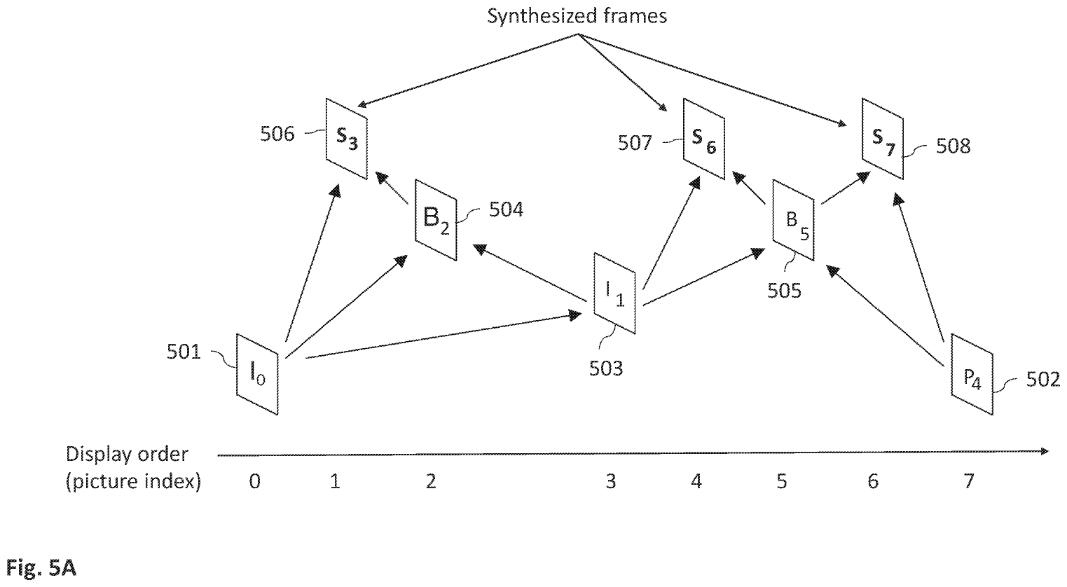

Since the GOP structure is fixed, a set of one or more positions which includes the first position within the GOP is determined in a recursive manner, using coded input frames of the GOP. The coded input frames include a starting frame with a start position (i.e. start index) and an ending frame with an end position (i.e. end index). The start position and end position are in display order. This is illustrated in FIG. 6, showing a predefined GOP of coded frames I0, b4, B2, b5, B2, b7,B6, b8, and P1. Three frames have positions idx=0 to idx=8 in display order. Frame 10 601 refers to the starting frame and frame P1 602 to the ending frame, with a start position idx=0 and end position idx=8,

The determination of the positions includes to recursively generate in coding order the synthesized frame at a current position between the start and end position, using the starting frame and the ending frame. The term coding order refers to the order in which a frame is generated by interpolation using two or more (neighboring) frames. This is illustrated in FIG. 6 by the different hierarchy levels (H level) 0 to 3, with 0 being the lowest and 3 the highest. In general, the coding start at H level 0 and progresses to the highest H level. The synthesized frame generated from 10 and P1 in coding order to frame B2 603.

Then, the quality measure (e.g. PSNR) is determined for frame B2 and it is determined whether or not the QM fulfills the predetermined condition. In the example shown in FIG. 6 (see figure box insert on the top right), the PSNR of B2 is not higher than e.g. 35. In other words, the QM does not fulfill the predetermined condition, in which case the content of an input frame at the current position (here idx=4) is encoded into the bitstream portion. In turn, when the QM fulfills the predetermined condition, and indication of the current position is included into the bitstream.

The recursion continues using the coded frames or synthesized frames at the start position and the current position, and/or at the current position and the end position. Accordingly, the determination which frame of the GOP should be replaced is performed during the encoding process (on-the-fly determination), because both coded frames and already synthesized frames are used. Hence, pre-processing may be reduced, accelerating the generation of the bitstream.

According to an aspect, the adaptively selecting frame process takes a starting frame with index S and an ending frame as inputs with index E, and synthesizes a frame in the middle of the starting and ending frames with index (S+E)/2. The quality of synthesized frame in the middle is compared to the input criterion quality. If its quality is higher than the given criterion, the frame in the middle is determined to be synthesized. The synthesized frame in the middle is used an anchor frame to synthesize other frames (if any). Otherwise, the frame in the middle is determined to be coded using an existing CODEC, and the original frame (i.e. input frame) is used to synthesize other frames (if any). Further, the adaptively selecting frame process repeats the for two new frame intervals, where in the first interval the starting and ending frame index is equal to S and (S+E)/2, and in the second interval, the starting and ending frame index is equal to (S+E)/2 and E, respectively. It is worth noting that the frame in the middle may be a synthetic frame or original frame. This bi-directional generation of synthetic frames is repeated and in each iteration the gap between anchor frames is halved (bisected). In the end, each frame between the frames with index S and E can be determined whether to be replaced or not. The recursion is started by initially setting the starting frame index to idx=0 and ending frame index to idx=N, and then in each iteration process N frames until the end of a video sequence. For each iteration, each frame between the starting and ending frames it is determined whether or not a frame is to be synthesized. Moreover, a list of sets of binary flags listSet[L][N−1] is collected. For each set, the size is fixed as N−1. Each flag with a value of 0 indicates using existing coded frames, and with a value of 1 indicates using synthetic frames. Suppose the length of a video sequence is K, and the length of list L is determined as (K−1)/N. The list of sets of binary flags is written into a bitstream. The coded frame position list might be written to a sequence-level header for a video coding at one place, or the coded frame position might be written to every N frames, from which the next N−1 frames, for each of them whether using synthetic or encoded frame can be determined. N shall be larger or equal to 2.

With reference to the example in FIG. 6, this means that the next recursion step uses frame 10 601 as starting frame and frame B2 603 as ending frame (continue recursion to the left). Likewise, continuing the recursion to the right means that frame B2 603 is us as the starting frame and frame P1 602 as the ending frame. In this way, frames are generated hierarchically in coding order. This order is shown in FIG. 6 at the top right, with the sequence 10-P1-B2-B3-b4-b5-B6-b7-b8. Except for the starting frames 10 and P1 at H level=0, the quality measure QM (e.g. PSNR) of frames B2 to b8 are successively checked, and determined whether at the current position of frames B2 to b8 an S frame is generated in the GOP. In the example of FIG. 6, the QM of frames b4, b5, and b7 fullfills the predetermined conditions (e.g. PSNR>35), in which case respective indications for the current position is included into the bitstream portion. This means that the positions at which an S frame is generated within the GOP are determined.

The processing on the encoder side may be also described as follows with reference to FIG. 6: The determination process identifies which frame from frames b4 to b8 (corresponding frame indices 1 to 7 in display order) shall be replaced with synthetic frames. Importantly, the frame type for the frames at the two ends of the respective GOP, i.e. the frame type of I0 601 and P₁ 602, are not changed. As noted before, 10 and P1 are the starting frame and ending frame at the start of the recursion. The first and last frames in a GOP provide initial frames for an interpolation module to synthesize other frames at higher hierarchy levels. Therefore, for a given GOP size of, for example, 8, at least one frame in every 8 frames would be coded, but not synthesized. The interpolation module may be a separate module or a part of generating module 812 of apparatus 800 shown in FIG. 8.

The determination process starts after frame I0 601 and P₁ 602 are coded. It uses the encoded I₀ and P₁ frames to synthesize frame B₂ 603. If the PSNR of synthesized frame B₂ is larger than a given PSNR value, then the synthesized frame B₂ is picked up. This means that an indication of the current position of B₂ is included into the bitstream portion. Otherwise, frame B₂ is encoded. This means that the content of an input frame at the current position of B₂ is encoded.

If there are one or more frames depending on B₂, then the frame (either synthesized or encoded) is put into a decoded frame buffer (DFB). Frames in the decoded frame buffer are even used in the encoder, by which reference pictures are provided for frames depending on them. As FIG. 6 shows, frame B₂ is referred to by frames B3 604, b5 606, b7 608, and B6 607. Therefore, frame B2 needs to be put to the decoded frame buffer. Accordingly, coded and/or synthesized frames are available in case of frame dependencies. Thus, the determination of S frames at higher hierarchy level may be performed while preserving frame dependencies.

The above process can be described in a more general way using the following steps:
1. Take as input a starting frame (I0: index=0) and an ending frame (P1: index=8) indicated by their respective frame index in display order.
2. Synthesize a frame as middle frame (B2, index=(0+8)/2), and calculate the PSNR of the synthetic frame.
3. If the calculated PSNR is larger than a given threshold, then pick up the synthesized frame. In this case, the position (e.g. index) of the S frame is included as indication into the bitstream portion.
4. Otherwise, encode the middle frame. This means that content of an input frame at the middle position (current position) is encoded into the bitstream portion.
5. Put the chosen frame (either synthesized or encoded) into a decoded frame buffer, if there are one or more frames depending on said middle frame.

After determining the frame type (whether synthesized or encoded normally) for frame at the current position with index idx=4 (B2) at hierarchy level 1, the processing repeats in a recursive manner the determination process for frame B3 at H level 2, using as the input a starting and ending frame with index equal to 0 and 4, respectively. In other words, at this step of the recursion, Io 601 is the starting frame and B2 603. In this example, 10 is a coded frame and as well as B2, which is a coded input frame as a result of the PSNR of B2 not fulfilling the predetermined condition. The result of the determination at the next recursion step shows that the PSNR of B3 is not high enough (i.e. is not larger than the given threshold e.g. 35), and hence B3 is encoded. In other words, the content of the input frame at the current position idx=2 is encoded into the bitstream portion.

After B3 is determined, the determination process again continues the recursion to determine the frame type of b4 and b5 at highest hierarchy level 3, using two GOPs each having a GOP size equal to 2. the frame type of b4 is determined from the GOP having frame 10 601 at idx=0 as starting frame and frame B3 604 at idx=2 as ending frame. Likewise, the frame type of b5 is determined from the GOP having frame B3 604 at idx=2 as starting frame and frame B2 603 at idx=4 as ending frame. Thus, the positions of the starting and ending frame used at the respective H levels may be specified in terms of pairs of picture indices of the respective GOP. In the example, these pairs are (0, 2), (2, 4), respectively. In this round of determination, both b4 605 and b5 606 satisfy the PSNR condition, and hence it is determined that a synthesized frame is generated at the current position idx=1 and iidx=3, respectively. It is noted that since no frame depends on b4 nor b5, frames b4 and b5 do not have to be put into the decoded picture buffer. This is a result that the highest H level in the example of FIG. 6 is 3 and is the level at which frames b4 and b5 are interpolated so that no frames exist at a higher H level that could depend on b4 or b5.

A similar recursive determination process can be applied to a GOP between frames with indices 4 to 8 (the index in display order). Among frames b7 608, B6 607, and b8 609, frame b7 is determined to be used in its synthesized form, as shown in the figure inset at the top right in FIG. 6. Finally, the frames of the GOP sequence would be coded in the order [I₀→P₁→B₂→B₃→S₄→S₅'B₆→S₇→b₈], wherein at the current positions of frames b₄, b₅, and b₇ indications of the respective current position is included into the bitstream portion. The above discussed determination process can be easily implemented with a binary search.

The determined positions of those frames need to be written in a bitstream, in order to signal the decoder, which frame needs to be synthesized. Usually, each encoded frame corresponds to two packages in the bitstream. The first bitstream package is frame header, indicating some high level syntax, such as the frame type. The second package includes a syntax for decoding the content of the frame (frame content), i.e. to reconstruct the frame from the bitstream. The first and second bitstream package are referred to as bitstream portion.

Normally, the header is lightweight, and most bits are written to the second package. For each frame, a flag may be written at the beginning of the frame's picture header to indicate whether said frame shall be synthesized or not. For example, if the flag is true, no other bits need to be written to the picture header, in which case the second package for the frame reconstruction (i.e. content decoding) is skipped as well. In the above example, the set flag=“true” indicates that the respective frame is to be synthesized. Therefore, said frame is not encoded. Alternatively, the flag may be set to “false” to indicate that the respective frame is to be synthesized.

In the above discussed example, the structure of the GOP is not changed. The unchanged GOP structure means that the length of frames [I BBB B BBB P] is neither shortened nor increased after one or more B frames are replaced within the GOP. Replacing means that, for the fixed GOP structure, at those positions of B frames of the GOP S frames are generated. Furthermore, the dependency/coding order between these frames are not changed, as shown in FIG. 6.

With the positions of S frames being signaled to the decoder via indications of positions within the bitstream, the decoder knows at which positions S frame should be generated within a GOP having a predefined GOP structure (i.e. fixed GOP structure). The decoder then generates frames of the GOP in a recursive manner, similar to the encoding side except for checking the quality measure. The GOP includes two or more frames, which are already generated, and the GOP comprises a starting frame with a start position and an ending frame with an end position. The respective positions are in display order.

At the beginning of the recursion, the two frames generated are frames whose content is decoded from the bitstream portion. The bitstream portion is then parsed for the indication of a current position between the start and end position. If the position indication is parsed (i.e. said indication is actually included in the bitstream portion), a synthesized frame is generated in decoding order at the current position from the starting frame and the ending frame. If the position indication is not parsed (i.e. said indication position is not included in the bitstream portion), then content of a current frame at the current position is decoded from the bitstream portion. Hence, the generated frames of the GOP include decoded frames and synthesized frames. The recursion is continued using the starting frame and, as the ending frame, the S frame or the decoded frame at the current position. This refers to continuing the recursion to the left. In turn, continuing to the right, the S frame or the decoded frame at the current position is used as the starting frame, and the ending frame. Accordingly, the frames of the GOP are generated using both decoded frames or already synthesized frames. Hence, frame of the GOP may be generated from a reduced number of decoded frames as a result of the lightweight bitstream.

According to an aspect, a list of sets of binary flags listSet[L][N−1] is obtained from a sequence-level header in a bitstream, from which every N−1 frames can be determined to be synthesized or to use an existing coded frame. Further, a set of binary flags Set[N−1] in the picture header of a current frame is obtained, and the current frame is the first frame of every N frames. From the Set[N−1], the next N−1 frames following the current frame can be determined to be synthesized or not. Moreover, a variable frame_idx is set to be zero, and a current frame is decoded. The decoded frame is added into a decoded picture buffer, and the frame idx is added into a list of decoded frame idx (frame idx list). It is then checked whether the length of frame_idx_list is larger than 2: If this is the case, frames in between the two decoded frames are synthesized, using the corresponding coded frames in the decoded picture buffer, in a hierarchical way (i.e. in decoding order).

In FIG. 6, the lower left part may be used to illustrate the decoding processing, which shows a GOP sequence of frames that are generated by the decoding side, based on the bitstream. As discussed before, frames 10, P1, B2, B3, B6, and b8 are coded into the bitstream portion. In turn, for frames S4 610, S5 611, and S7 612, their respective positions within the GOP are included as indications into the bitstream. This means that the decoder decodes at least frames 10 and P1 at H level 0, and subsequently frames B2, B3, for which the bitstream does not carry indications on their respective positions. Since the frames of the GOP are generated in decoding order, the next frame in this order is S4 610. In this case, the bitstream carries an indication of the position as which the S frame should be generated. This position indication is parsed and the S frame is generated from decoded frames Io 601 and B3 604. The recursion continues with frames S5 611, B6 607, S7 612, and b8 609 following the decoding order shown in FIG. 6 at the bottom right. Since the GOP structure is predefined (i.e. fixed), the number of frames within the GOP neither shrinks nor grows. In case of one or more of the generated frames depend on the frame at the current position, the respective frame generated at the current position is put into a decoded frame buffer. Accordingly, decoded frames are available in case of frame dependencies. Thus, S frames which may depend on decoded frames may be generated accurately at higher hierarchy level while preserving frame dependencies.

### Embodiment 4

The frame-level based approach discussed in the previous embodiment imposes a limitation on the coding order. For example, the determined frame type for frames with indices 0 to 8 in display order is [I B S B B B S B P], wherein S represents a synthetic frame. Such a determination result can be applied for a random access configuration with a GOP size of 8, for example. However, such a frame sequence of a GOP is not compatible with a low delay configuration. This is because, in the sequence [I B S B B B S B P], the frame with index idx=2 is synthesized, and hence may require that the frame with index idx=4 shall be decoded first. However, in a low delay configuration, the coding order and display order shall be the same, and the frame with index idx=4 shall not be decoded before the frame with index idx=2.

For this reason, a more coarse-grained determination method is generalized for low delay scenario. For a low delay configuration, the input parameter of a lookahead constant may be required. The lookahead constant is basically the maximum allowed GOP size. The look ahead constant may be predefined and determines a maximum number of synthesized frames that can be generated for the GOP.

A low delay scenario may be implemented in that a set of one or more positions of a next coded frame within a GOP is determined. The set of positions include a first position at which an S frame may be generated. Further, the GOP includes, as coded input frames, a starting frame with a start position and an ending frame with an end position, with said positions being in display order. In FIG. 7, an example of a GOP of size 8 is shown, where frame 701 at idx=0 and frame 702 at idx=8 is a starting frame and an ending frame, respectively. These frames are coded frames as marked by the solid dash box in FIG. 7.

Then, one or more S frames (frames 703 to 709 in FIG. 7) are generated recursively in coding order for the GOP size and the predefined look ahead constant from the starting frame 701 and the ending frame 702. The current position of the respective S frames (positions idx=1 to idx=7 in FIG. 7) is between the start position idx=0 and end position idx=8. This means that in the first step of the recursion starting with a GOP size of 8 in FIG. 7, S frames are generated at picture indices idx=4, 2, 1, 3, 6, 5, and 7 in coding order. The coding order is also illustrated at the top right in FIG. 7. For each of the S frames, their respective quality measure QM (e.g. PSNR) is determined, and checked whether or not the predetermined conditions is fulfilled. Examples of quality measure have been already provided earlier.

When the QM fulfills the predetermined condition for each of the S frames (e.g. PSNR larger than 35), the ending frame is determined as the next frame that is encoded, in which case the content of the ending frame at the end position is encoded into the bitstream portion. For example, if the PSNR of all S frames 703 to 709 is sufficiently high, frame 702 at idx=8 would be the next frame whose content is encoded.

In turn, when any of the QM of the S frames does not fulfill the predetermined condition, the recursion is continued by bisection the GOP size, and the start position and end position of the input frames of the respective bisected GOP is used. In FIG. 7, the original GOP size is 8, and in case the PSNR of any of the S frames is not larger than 35 (i.e. the predetermined condition is not fulfilled), GOP=8 is bisected to anew GOP of 4. The GOP with size 4 has frame 701 at idx=0 and frame 703 at idx=4, corresponding the start position and end position, respectively. Then, S frames 704 to 706 are generated in coding order at positions between idx=0 and idx=4, and their QM is determined and checked whether the QM fulfills the predetermined condition. If fulfilled, then the next frame to be encoded is frame 703 whose content is encoded into the bitstream portion. If not fulfilled, the recursion continues until a bisected GOP size of 2. In this case, only one S frame 705 can be generated between frames 701 (start position idx=0) and frame 704 (end position idx=2). This step of the recursion is special in that, when the QM does not fulfill the predetermined condition, the next frame to be encoded is the coded input frame immediately following the starting frame in display order. Again, the content of an input frame at the current position of the next frame is encoded into the bitstream portion. In other words, at GOP size 2, the next frame 705 to be encoded may be located between the starting frame 701 and ending frame 704. Accordingly, the number of synthesized frames that are to be generated for the GOP is determined and dynamically adapted during the encoding process.

According to an aspect, the adaptively selecting frame process takes a starting frame with index S and an ending frame as inputs with index E, and synthesizes a frame in the middle of the starting and ending frames with index (S+E)/2. The synthesized frame in the middle could be again used as an anchor frame, to generate synthesized frames between two new intervals. In the first interval, the starting and ending frame index, respectively equals to S and (S+E)/2, and in the second interval the starting and ending frame index, respectively equals (S+E)/2 and E. This bi-directional generation of synthetic frames is repeated, and in each iteration the gap between anchor frames is halved. In the end, the synthetic frame are generated hierarchically. For example, the adaptively selecting frame process sets the starting frame and ending frame to be the original frames (i.e. input frames) with index=0 and index=N, respectively. When the quality of all synthetic frames between the starting frame and the ending frame are larger than or equal to the input criterion quality, these frames are determined to be replaced with synthetic frames. In turn, when the quality of at least one of the frame between the starting frame and the ending frame is smaller than the input criterion quality, the input parameter N is shrunk by half (bisected), the starting and ending frames are set to be frames with index=0 and index=N/2, and further determine the quality of synthesized frames between frame 0 to N/2. If there is still at least one synthetic frame whose quality is smaller than the given criterion quality, then further shrink the input N by half, until the ending frame becomes frame with index=1. This frame would correspond to frame 705 in FIG. 7.

As may be discerned from FIG. 7, the GOP size and the bisected GOP sizes correspond to differences in position between successive next frames to be encoded into the bitstream portion. For example, assuming that the recursion would stop at GOP size 4, the next frame to be encoded would be frame 704 at position idx=4. Hence, the GOP size of 4 corresponds to the position difference between the successive encoded frames 701 and 703. Accordingly, positions of next coded frames can be determined easily from GOP sizes.

According to an aspect, the adaptively selecting frame process determines a number M, indicating the position of next frame which shall be coded by the existing codec (i.e. the coded frame position of the next coded frame), whereas the frames between frame 0 and frame M are all synthesized. The number M refers to the GOP size. Moreover, the adaptively selecting frame process sets a new starting and ending frames with index=M and index=M+N, to determine position of the next coded frame in a new window (M, M+N) (i.e. a second GOP size), and repeat the process to the end of a video sequence.

According to an aspect, the determined coded frame M is collected in a list of coded frames positions (M₀, M₁, M₂ . . . M_{E}), where M_{E} indicates the last coded frame position in a video sequence. Write the coded frame position list into a bitstream. As frame 0 is always a coded frame, the Mo corresponds to the position of the second coded frame. The coded frame position might be written to a bitstream in a directly way (the index of the coded frame), or in an indirectly (the difference to the previous coded frames), i.e. (M₀, M₁−M₀, M₂−M₁, . . . ). The coded frame position list might be written to a sequence-level header for a video coding at one place, or the coded frame position might be written to a frame-level header, from which the next coded frame position can be obtained. For example, for frame 0, M₀ is signaled in its header. For frame M₀, M₁ or M₁−M₀ is signaled in its picture header.

The processing on the encoder side may be also described as follows with reference to FIG. 7. When the lookahead constant is given as 8, for example, the encoder synthesizes all frames with indices idx=1 to idx=7 hierarchically, as shown in step 1 of FIG. 7. Hierarchically synthesizing means generating S frames in coding order, but with positions in display order. If the PSNR of all of each of frames 703 to 709 are larger than a given threshold 35, then all these frames are determined to be synthesized. Otherwise, the GOP size is shrunk by half (i.e. the GOP is bisected), and it is determined whether frames 704 to 706 with indices idx=1 to 3 can be all synthesized or not, as shown in step 2 of FIG. 7. If it is determined that not all frames can be synthesized, then the GOP size is successively reduced until a GOP size of 1. This means that the frame with index idx=1 is not synthesized.

The above coarse-grained determination process would return a GOP size corresponding to one value in a set of (8, 4, 2, 1) for a given input of the lookahead constant number of 8 in this example. The returned GOP size determines the position of a next coded frame, i.e. normally encoded frame. If one assumes for illustrative purposes that the returned next coded frame is a frame with index idx=4 (frame 703), the encoder would repeat the above same determination process, but would proceed with the next GOP using frame 703 as a starting frame with index idx=4 and ending frame with index idx=4+8=4+returned GOP size=12. The above determination process is repeated for the whole GOP sequence, and a list of GOP sizes is collected, from which the coded frame positions can be determined.

For example, suppose that 13 frames of a GOP sequence are encoded, and the determined GOP size list is [4, 8]. Said GOP size list indicates, except for the first frame with index idx=0, that the next two coded frames are those with an index idx=0+4=4 (the next coded frame after frame 0), and index idx=4+8=12 (the next coded frame after frame 4). All other frames, except frames with index 0, 4, 12 between 0 to 12, are synthesized as they are not coded frames.

Regarding the signaling in the bitstream, when coding the frame with index idx=0, the first determined GOP size (e.g. 4) can be signaled as well. This means that the bitstream includes an indication of a first position within a GOP at which an S frame is generated, along with an indication of one or more GOP sizes. Accordingly, the positions at which S frames are generated within the GOP may be easily determined from the GOP sizes.

The processing to generate the frames of the GOP is similar to the encoding side, except for determining and check of the QM. After content of coded frames are decoded from the bitstream, the GOP comprises already two decoded frames. The frames of the GOP of the vide sequence are generated in a recursive manner in that the two decoded frames are used as starting frame with start position and an ending frame with an end position. Start and end position are in display order. Then, the bitstream portion is parsed for the indication of a first GOP size among the one or more GOP sizes.

According to an aspect, a list of coded frame positions ((M₀, M₁, M₂ . . . M_{E}) or (M₀, M₁−M₀, M₂−M₁, . . . ) are obtained from a sequence-level header in a bitstream (e.g. by parsing the bitstream), from which all coded frame positions in a video sequence can be determined. Further, a difference D between the next coded frame and the current frame from the picture header of the current frame. For example, M₀ for frame 0, and M₁−M₀ for frame M₀, etc. From D the next coded frame position can be determined. Moreover, a variable frame_idx is set to be zero. A current frame is decoded, the decoded frame is added into a decoded picture buffer. The frame_idx is added into a list of decoded frame indices (frame_idx_list). It is checked whether the length of frame_idx_list is larger than 2, and the difference between the last two elements in the frame_idx_list is larger than 1. If this is the case, frames are synthesized in the two coded frames that were just decoded, using the corresponding coded frames in decoded picture buffer, in a hierarchical way (i.e. in decoding order).

Using this information, the decoder can then, after decoding the frames at indices idx=0 and idx=4. In this case, the first GOP size is 4. The decoded frames are 701 and 703 at idx=0 and idx=4 in FIG. 7. The decoder can now fill the gap between decoded frames 701 and 703 by interpolating frames between those coded frames hierarchically (i.e. in decoding order). The frames 701 and 703 are the starting and ending frame, respectively, with S frames 704 to 705 being generated from the starting frame 701 and ending frame 703 in decoding order at positions idx=2, 1, and 3 in display order between start position idx=0 and idx=4. At this step of the recursion, the frames of a first GOP are generated.

The recursion continues by using as the starting frame the ending frame of the previous recursion step. In FIG. 7 with the first GOP size being 4, said ending frame would be frame 703. As the ending frame, the decoded frame based on a next GOP size subsequent to said first GOP size is used. For example, assuming that the subsequence GOP size is 4 (second GOP size), then the position of the next decoded frame within the GOP would be idx=GOP size 1+GOP size 2=4+4=8. Thus, the ending frame would be the decoded frame at idx=8, and S frames are generated in decoding order between positions idx=4 and idx=8.

From the above discussion, it is important that the distance to the next coded frame is signaled into the bitstream portion, since the decoder may not know if any and how many frames of the GOP have to be synthesized. As compared to FRUC, the amount of dropped frames is not predetermined (i.e. fixed), but decided and dynamically adjusted during the encoding process.

For all intra configurations, i.e. all images are encoded with intra prediction only without inter-prediction. The coding order and display order are the same. The same algorithm can be applied.

The present disclosure may be summarized as follows: The above discussed embodiments adaptively interpolate frames without bit cost for the content generation, for which a neural network may be used. The results for the positions of synthesized frames are written into the bitstream portion, so that it can be indicated to the decoder which frames of the video sequence should be synthesized at the respective position. As already discussed, the determination of the frame type initially uses original frames (i.e. input frames of the video sequence) as inputs for synthesizing S frames, and might use also those generated synthesized frames recursively to generate another synthesized frame at a higher hierarchical level. However, during encoding and decoding, the input of synthesized frames are encoded or decoded frames as the initial input. It is also noted that, for random access and low delay configurations, the determination of synthesized frames is slightly different.

Main aspects of the present disclosure include content adaptivity, generic to existing CODECs, enabling bi-directional interpolation for all intra-prediction and uni-prediction CODECs, and improved compression without increasing the encoding/decoding latency. This is a result of employing a quality measure for generated S frames to determine whether it may be required to encode content of an input frame at a position of the generated S frame (low S frame quality) or to simply include a position indication of the respective position into the bitstream portion (high S frame quality). The more S frames are determined to be generated, the less content (i.e. input frames) needs to be encoded into the bitstream, and hence saves bit cost of the encoding. In that respect, even though the quality measure refers to the quality of the generated S frame, it may be also interpreted as being a measure for the quality of those frames (either input frames or already synthesized frames) that are used to generate the S frame. Therefore, the bitstream includes encoded content of those frames which (i) ensure generating S frame of a sufficient quality and/or (ii) are needed at certain positions since the quality of an S frame would be too low otherwise.

As discussed above, in embodiment 2 it is determined which frames should be synthesized. For a random access configuration, the approach uses the same GOP structure at the encoder, and determines whether a frame in a GOP should be synthesized or not based on a frame quality criterion.

In turn, the a low delay configuration of embodiment 4, the approach takes as input a maximum GOP size and the frame quality criterion. If each of all synthesized frames between the first frame and end frame with index idx=max_GOP can satisfy the criterion, then the given maximum GOP size is returned. Otherwise, the GOP size is shrunk (bisected), and the encoder determines whether all frames between the first frame and the ending frame with index idx=max_GOP/2 can satisfy the criterion. The max_GOP can be shrunk until it becomes one, indicating that the next coded frame is the frame right next to the very first frame. In FIG. 7, such next frame would be frame 705. After the next coded frame is determined, the encoder will repeat the determination process for a new GOP window (i.e. GOP size) having initial starting and ending frames with indices as (return_GOP, return_GOP+max_GOP). Hence, by signaling GOP sizes, the decoder knows the position of subsequently decoded frames within the video sequence, based on which S frames are generated between the starting and ending frame of the GOP. This process is repeated until to the end of a video sequence.

Both of the above approaches can determine which frames should be synthesized adaptively, based on the given criterion. The position of synthetic frames can be adapted to the frame content in a video sequence. For example, if in a GOP the motion changes strongly, then the frame interpolation is likely not to work very well. In such a case, the encoder might determine that no frames should be synthesized. On the other hand, if in a GOP the content is rather stationary (i.e. still-like) and frame interpolation works well as a normal encoder does, then a majority of frames in a GOP are likely determined to be synthesized.

By contrast, FRUC would only synthesize frames evenly across a GOP sequence, and hence no no content adaptation is achieved.

As discussed above, a new type of frame, namely a synthetic frame, is added and their positions are determined at the encoder side, and the respective positions are signaled into a bitstream to the decoder. The decoder then derives the positions of these synthetic frames by parsing the bitstream for an indication of those positions. It is noted that the present disclosure is suitable for any existing CODEC, making the approach of the present disclosure generic. Over and above, any of the approaches discussed above is well defined and can be easily implemented on top of a target CODEC.

It is noted further that, tn some cases, a target CODEC might be only capable to perform intra prediction or uni-directional inter prediction. This is particularly true in the case of artificial intelligence based video codec, wherein most of the work are based on an image CODEC (no temporal inter prediction). When applying the approaches of the present disclosure on such codecs, bi-directional interpolation capability for the target CODEC is enabled, because a synthetic frame uses bi-directional interpolation from two key frames encoded by target CODEC.

The approaches of the present disclosure discussed above target a better compression by replacing low quality input frames with synthesized frames. Replacing means that, instead encoding low quality input frames at a current position, an S frame is to be generated at the current position. Since we just replace coding frames with synthetic frames, the encoding and decoding latency would not increase. Suppose, for example, a target CODEC with GOP size 4 in a random access configuration has a coding structure as IBBBPBBBPBBBP . . . , and the determination approach changes the frames type as ISBSPSBSPSBSP . . . . i.e. all odd frames (frame index starting from 0) are determined to be replaced. In this case, on the encoder side, the S frames do need to be encoded, butjusta position of these synthetic frames is included into the bitstream portion, and hence signaled to the decoder. Therefore, the encoder essentially encodes input frames of the video sequence having the picture types of a structure IBPBPBP . . . . From encoder perspective, the encoding latency is reduced by half. On the decoder, the latency is still four since S frames are to be generated.

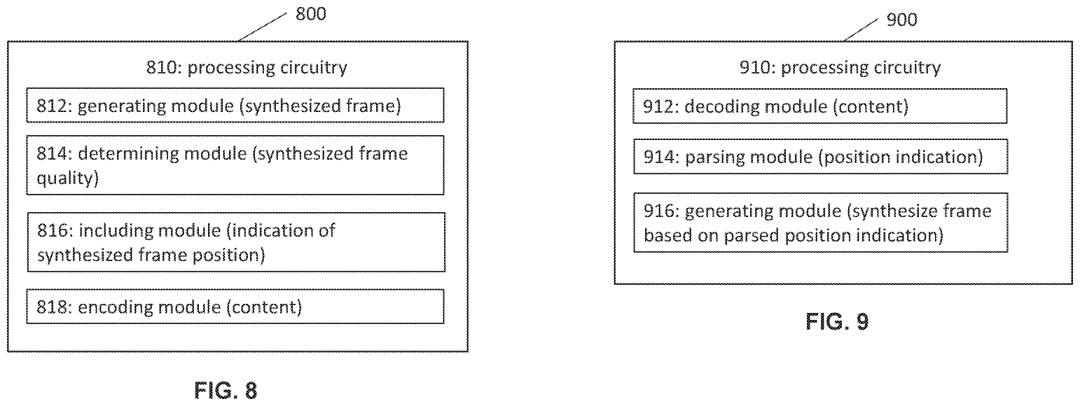

The above described generation of the bitstream (encoding side) and the generation of the frames (decoding side) may be realized in a software implementation. FIG. 10 shows an exemplary flowchart of a method for generating a bitstream representing input frames of a video sequence. In step S1010, a synthesized frame is generated at a first position of a first input frame based on two or more input frames. A quality measure (QM) is then determined for the synthesized frame in step S1020. In step S1030, it is tested whether or not the QM fulfills a predetermined condition. When the QM fulfills said condition (step S1030: “YES”), then an indication of the first position is included into the bitstream portion. If the QM does not fulfill said condition (step S1030: “NO”), then content of the first input frame is encoded into the bitstream portion. The (en) coding processing may be performed, for example, by encoder 20 shown in FIG. 12, which executes instructions of a respective program according to the above method steps.

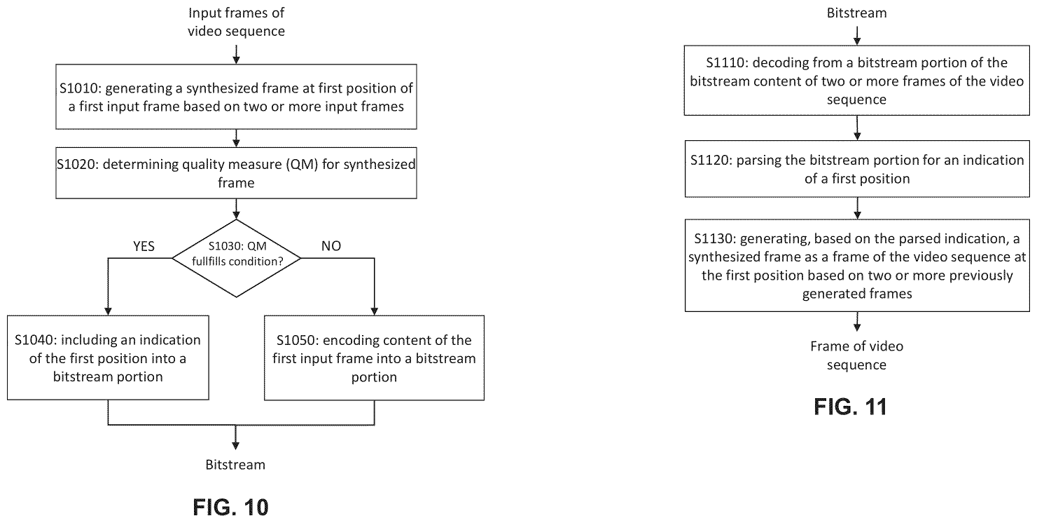

Likewise, FIG. 11 shows an exemplary flowchart of a method to generate frames of a video sequence from a bitstream representing the video sequence. In step S1110, content of two or more frames of the videos sequence is decoded from a bitstream portion. Further, the bitstream portion is parsed for an indication of a first position instep S1120. Based on the parsed indication, a synthesized frame is generated as a frame of the video sequence as the first position, based on the two or more previously generated frames (step S1130). The decoding processing may be performed, for example, by decoder 30 shown in FIG. 13, which executes instructions of a respective program according to the above method steps.

In a further embodiment, a computer-readable non-transitory medium stores a program, including instructions which when executed on one or more processors cause the one or more processors to perform any of the above methods.

In another embodiment of the present disclosure, an apparatus for generating a bitstream representing input frames of a video sequence, comprises: one or more processors; and a non-transitory computer-readable storage medium coupled to the one or more processors and storing programming for execution by the one or more processors, wherein the programming, when executed by the one or more processors, configures the apparatus to carry out the method for generating a bitstream representing input frames of a video sequence.

In another embodiment of the present disclosure, an apparatus for generating frames of a video sequence from a bitstream representing the video sequence, comprises: one or more processors; and a non-transitory computer-readable storage medium coupled to the one or more processors and storing programming for execution by the one or more processors, wherein the programming, when executed by the one or more processors, configures the apparatus to carry out the method for generating frames of a video sequence from a bitstream representing the video sequence.

In a further embodiment, a computer program comprises a program code for performing the method when executed on a computer according to any one of the above methods.

The person skilled in the art will understand that the “blocks” (“units”) or “modules” of the various figures (method and apparatus) represent or describe functionalities of embodiments of the present disclosure (rather than necessarily individual “units” in hardware or software) and thus describe equally functions or features of apparatus embodiments as well as method embodiments.

The terminology of “units” and/or “modules” is merely used for illustrative purposes of the functionality of embodiments of the encoder/decoder and are not intended to liming the disclosure.

In the several embodiments provided in the present application, it should be understood that the disclosed system, apparatus, and method may be implemented in other manners. For example, the described apparatus embodiment is merely exemplary. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, optical, mechanical, or other forms.

The units described as separate parts may or may not be physically separate, and parts displayed as units may or may not be physical units, may be located in one position, or may be distributed on a plurality of network units. Some or all of the units may be selected according to actual needs to achieve the the solutions of the embodiments.

In addition, the functional units in the embodiments of the present disclosure may be integrated into one processing unit, or each of the units may exist alone physically, or two or more units are integrated into one unit.

Some further implementations in hardware and software are described in the following.

As mentioned above, HEVC may be used to encode the content of input frames, such as the first input frame in some embodiments. Likewise, HEVC may be used also for decoding the content from the bitstream portion. The present disclosure is not limited to the examples presented above. It is conceivable to also employ embodiments of the present disclosure within a codec such as the HEVC or another codec. Accordingly, in the following, the HEVC function is briefly described.

An implementation example of a HEVC encoder and decoder is shown FIG. 12 and FIG. 13. FIG. 12 shows a schematic block diagram of an example video encoder 20 that is configured to implement the techniques of the present disclosure. In the example of FIG. 12, the video encoder 20 comprises an input 201 (or input interface 201), a residual calculation unit 204, a transform processing unit 206, a quantization unit 208, an inverse quantization unit 210, and inverse transform processing unit 212, a reconstruction unit 214, a loop filter unit 220, a decoded picture buffer (DPB) 230, a mode selection unit 260, an entropy encoding unit 270 and an output 272 (or output interface 272). The decoded picture buffer may be also referred to as decoded frame buffer (DFB). The mode selection unit 260 may include an inter prediction unit 244, an intra prediction unit 254 and a partitioning unit 262. Inter prediction unit 244 may include a motion estimation unit and a motion compensation unit (not shown). A video encoder 20 as shown in FIG. 12 may also be referred to as hybrid video encoder or a video encoder according to a hybrid video codec.

The inverse quantization unit 210, the inverse transform processing unit 212, the reconstruction unit 214, the loop filter 220, the decoded picture buffer (DPB) 230, the inter prediction unit 244 and the intra-prediction unit 254 are also referred to forming the “built-in decoder” of video encoder 20.

The encoder 20 may be configured to receive, e.g. via input 201, a picture 17 (or picture data 17), e.g. picture of a sequence of pictures forming a video or video sequence. The received picture or picture data may also be a pre-processed picture 19 (or pre-processed picture data 19). For sake of simplicity the following description refers to the picture 17. The picture 17 may also be referred to as current picture or picture to be coded (in particular in video coding to distinguish the current picture from other pictures, e.g. previously encoded and/or decoded pictures of the same video sequence, i.e. the video sequence which also comprises the current picture).

A (digital) picture is or can be regarded as a two-dimensional array or matrix of samples with intensity values. A sample in the array may also be referred to as pixel (short form of picture element) or a pel. The number of samples in horizontal and vertical direction (or axis) of the array or picture define the size and/or resolution of the picture. For representation of color, typically three color components are employed, i.e. the picture may be represented or include three sample arrays. In RBG format or color space a picture comprises a corresponding red, green and blue sample array. However, in video coding each pixel is typically represented in a luminance and chrominance format or color space, e.g. YCbCr, which comprises a luminance component indicated by Y (sometimes also L is used instead) and two chrominance components indicated by Cb and Cr. The luminance (or short luma) component Y represents the brightness or grey level intensity (e.g. like in a grey-scale picture), while the two chrominance (or short chroma) components Cb and Cr represent the chromaticity or color information components.

Embodiments of the video encoder 20 may comprise a picture partitioning unit 262 configured to partition the picture 17 into a plurality of (typically non-overlapping) picture blocks 203. These blocks may also be referred to as root blocks, macro blocks (H.264/AVC) or coding tree blocks (CTB) or coding tree units (CTU) (H.265/HEVC and VVC). The picture partitioning unit may be configured to use the same block size for all pictures of a video sequence and the corresponding grid defining the block size, or to change the block size between pictures or subsets or groups of pictures, and partition each picture into the corresponding blocks.

Embodiments of the video encoder 20 as shown in FIG. 12 may be configured to encode the picture 17 block by block, e.g. the encoding and prediction is performed per block 203.

The quantization unit 208 may be configured to quantize the transform coefficients 207 to obtain quantized coefficients 209, e.g. by applying scalar quantization or vector quantization. The quantized coefficients 209 may also be referred to as quantized transform coefficients 209 or quantized residual coefficients 209.

The quantization process may reduce the bit depth associated with some or all of the transform coefficients 207. For example, an n-bit transform coefficient may be rounded down to an m-bit Transform coefficient during quantization, where n is greater than m. The degree of quantization may be modified by adjusting a quantization parameter (QP). For example for scalar quantization, different scaling may be applied to achieve finer or coarser quantization. Smaller quantization step sizes correspond to finer quantization, whereas larger quantization step sizes correspond to coarser quantization. The applicable quantization step size may be indicated by a quantization parameter (QP). The quantization parameter may for example be an index to a predefined set of applicable quantization step sizes. For example, small quantization parameters may correspond to fine quantization (small quantization step sizes) and large quantization parameters may correspond to coarse quantization (large quantization step sizes) or vice versa. The quantization may include division by a quantization step size and a corresponding and/or the inverse dequantization, e.g. by inverse quantization unit 210, may include multiplication by the quantization step size. Embodiments according to some standards, e.g. HEVC, may be configured to use a quantization parameter to determine the quantization step size. Generally, the quantization step size may be calculated based on a quantization parameter using a fixed point approximation of an equation including division. Additional scaling factors may be introduced for quantization and dequantization to restore the norm of the residual block, which might get modified because of the scaling used in the fixed point approximation of the equation for quantization step size and quantization parameter. In one example implementation, the scaling of the inverse transform and dequantization might be combined. Alternatively, customized quantization tables may be used and signaled from an encoder to a decoder, e.g. in a bitstream. The quantization is a lossy operation, wherein the loss increases with increasing quantization step sizes.

Embodiments of the video encoder 20 (respectively quantization unit 208) may be configured to output quantization parameters (QP), e.g. directly or encoded via the entropy encoding unit 270, so that, e.g., the video decoder 30 may receive and apply the quantization parameters for decoding.

The inverse quantization unit 210 is configured to apply the inverse quantization of the quantization unit 208 on the quantized coefficients to obtain dequantized coefficients 211, e.g. by applying the inverse of the quantization scheme applied by the quantization unit 208 based on or using the same quantization step size as the quantization unit 208. The dequantized coefficients 211 may also be referred to as dequantized residual coefficients 211 and correspond—although typically not identical to the transform coefficients due to the loss by quantization—to the transform coefficients 207.

The reconstruction unit 214 (e.g. adder or summer 214) is configured to add the transform block 213 (i.e. reconstructed residual block 213) to the prediction block 265 to obtain a reconstructed block 215 in the sample domain, e.g. by adding—sample by sample—the sample values of the reconstructed residual block 213 and the sample values of the prediction block 265.

The above mentioned quantization parameter is one of the possible encoding parameters that may be set based on the importance according to some embodiments. Alternatively or in addition, the partitioning, the prediction type or loop-filtering may be used.

The loop filter unit 220 (or short “loop filter” 220), is configured to filter the reconstructed block 215 to obtain a filtered block 221, or in general, to filter reconstructed samples to obtain filtered samples. The loop filter unit is, e.g., configured to smooth pixel transitions, or otherwise improve the video quality. The loop filter unit 220 may comprise one or more loop filters such as a de-blocking filter, a sample-adaptive offset (SAO) filter or one or more other filters, e.g. a bilateral filter, an adaptive loop filter (ALF), a sharpening, a smoothing filters or a collaborative filters, or any combination thereof. Although the loop filter unit 220 is shown in FIG. 12 as being an in loop filter, in other configurations, the loop filter unit 220 may be implemented as a post loop filter. The filtered block 221 may also be referred to as filtered reconstructed block 221.

Embodiments of the video encoder 20 (respectively loop filter unit 220) may be configured to output loop filter parameters (such as sample adaptive offset information), e.g. directly or encoded via the entropy encoding unit 270, so that, e.g., a decoder 30 may receive and apply the same loop filter parameters or respective loop filters for decoding.

The decoded picture buffer (DPB) 230 may be a memory that stores reference pictures, or in general reference picture data, for encoding video data by video encoder 20. The DPB 230 may be formed by any of a variety of memory devices, such as dynamic random access memory (DRAM), including synchronous DRAM (SDRAM), magneto-resistive RAM (MRAM), resistive RAM (RRAM), or other types of memory devices.

The mode selection unit 260 comprises partitioning unit 262, inter-prediction unit 244 and intra-prediction unit 254, and is configured to receive or obtain original picture data, e.g. an original block 203 (current block 203 of the current picture 17), and reconstructed picture data, e.g. filtered and/or unfiltered reconstructed samples or blocks of the same (current) picture and/or from one or a plurality of previously decoded pictures, e.g. from decoded picture buffer 230 or other buffers (e.g. line buffer, not shown). The reconstructed picture data is used as reference picture data for prediction, e.g. inter-prediction or intra-prediction, to obtain a prediction block 265 or predictor 265.

Mode selection unit 260 may be configured to determine or select a partitioning for a current block prediction mode (including no partitioning) and a prediction mode (e.g. an intra or inter prediction mode) and generate a corresponding prediction block 265, which is used for the calculation of the residual block 205 and for the reconstruction of the reconstructed block 215.

Embodiments of the mode selection unit 260 may be configured to select the partitioning and the prediction mode (e.g. from those supported by or available for mode selection unit 260), which provide the best match or in other words the minimum residual (minimum residual means better compression for transmission or storage), or a minimum signaling overhead (minimum signaling overhead means better compression for transmission or storage), or which considers or balances both. The mode selection unit 260 may be configured to determine the partitioning and prediction mode based on rate distortion optimization (RDO), i.e. select the prediction mode which provides a minimum rate distortion. Terms like “best”, “minimum”, “optimum” etc. in this context do not necessarily refer to an overall “best”, “minimum”, “optimum”, etc. but may also refer to the fulfillment of a termination or selection criterion like a value exceeding or falling below a threshold or other constraints leading potentially to a “sub-optimum selection” but reducing complexity and processing time. The RDO may be also used to select one or more parameters based on the importance determined.

In other words, the partitioning unit 262 may be configured to partition the block 203 into smaller block partitions or sub-blocks (which form again blocks), e.g. iteratively using quad-tree-partitioning (QT), binary partitioning (BT) or triple-tree-partitioning (TT) or any combination thereof, and to perform, e.g., the prediction for each of the block partitions or sub-blocks, wherein the mode selection comprises the selection of the tree-structure of the partitioned block 203 and the prediction modes are applied to each of the block partitions or sub-blocks.

The partitioning unit 262 may partition (or split) a current block 203 into smaller partitions, e.g. smaller blocks of square or rectangular size. These smaller blocks (which may also be referred to as sub-blocks) may be further partitioned into even smaller partitions. This is also referred to tree-partitioning or hierarchical tree-partitioning, wherein a root block, e.g. at root tree-level 0 (hierarchy-level 0, depth 0), may be recursively partitioned, e.g. partitioned into two or more blocks of a next lower tree-level, e.g. nodes at tree-level 1 (hierarchy-level 1, depth 1), wherein these blocks may be again partitioned into two or more blocks of a next lower level, e.g. tree-level 2 (hierarchy-level 2, depth 2), etc. until the partitioning is terminated, e.g. because a termination criterion is fulfilled, e.g. a maximum tree depth or minimum block size is reached. Blocks which are not further partitioned are also referred to as leaf-blocks or leaf nodes of the tree. A tree using partitioning into two partitions is referred to as binary-tree (BT), a tree using partitioning into three partitions is referred to as ternary-tree (TT), and a tree using partitioning into four partitions is referred to as quad-tree (QT).

As mentioned before, the term “block” as used herein may be a portion, in particular a square or rectangular portion, of a picture. With reference, for example, to HEVC and VVC, the block may be or correspond to a coding tree unit (CTU), a coding unit (CU), prediction unit (PU), and transform unit (TU) and/or to the corresponding blocks, e.g. a coding tree block (CTB), a coding block (CB), a transform block (TB) or prediction block (PB).

For example, a coding tree unit (CTU) may be or comprise a CTB of luma samples, two corresponding CTBs of chroma samples of a picture that has three sample arrays, or a CTB of samples of a monochrome picture or a picture that is coded using three separate colour planes and syntax structures used to code the samples. Correspondingly, a coding tree block (CTB) may be an N×N block of samples for some value of N such that the division of a component into CTBs is a partitioning. A coding unit (CU) may be or comprise a coding block of luma samples, two corresponding coding blocks of chroma samples of a picture that has three sample arrays, or a coding block of samples of a monochrome picture or a picture that is coded using three separate colour planes and syntax structures used to code the samples. Correspondingly a coding block (CB) may be an M×N block of samples for some values of M and N such that the division of a CTB into coding blocks is a partitioning.

In embodiments, e.g., according to HEVC, a coding tree unit (CTU) may be split into CUs by using a quad-tree structure denoted as coding tree. The decision whether to code a picture area using inter-picture (temporal) or intra-picture (spatial) prediction is made at the CU level. Each CU can be further split into one, two or four PUs according to the PU splitting type. Inside one PU, the same prediction process is applied and the relevant information is transmitted to the decoder on a PU basis. After obtaining the residual block by applying the prediction process based on the PU splitting type, a CU can be partitioned into transform units (TUs) according to another quadtree structure similar to the coding tree for the CU.

Different sizes of the blocks, or maximum and/or minimum of the blocks obtained by partitioning may be also part of the encoding parameters, as different sizes of blocks will result in different coding efficiencies.

In one example, the mode selection unit 260 of video encoder 20 may be configured to perform any combination of the partitioning techniques described herein.

As described above, the video encoder 20 is configured to determine or select the best or an optimum prediction mode from a set of (e.g. pre-determined) prediction modes. The set of prediction modes may comprise, e.g., intra-prediction modes and/or inter-prediction modes.

FIG. 13 shows an example of a video decoder 30 that is configured to implement the techniques of this present application. The video decoder 30 is configured to receive encoded picture data 21 (e.g. encoded bitstream 21), e.g. encoded by encoder 20, to obtain a decoded picture 331. The encoded picture data or bitstream comprises information for decoding the encoded picture data, e.g. data that represents picture blocks of an encoded video slice (and/or tile groups or tiles) and associated syntax elements.

In the example of FIG. 13, the decoder 30 comprises an entropy decoding unit 304, an inverse quantization unit 310, an inverse transform processing unit 312, a reconstruction unit 314 (e.g. a summer 314), a loop filter 320, a decoded picture buffer (DBP) 330, a mode application unit 360, an inter prediction unit 344 and an intra prediction unit 354. Inter prediction unit 344 may be or include a motion compensation unit. Video decoder 30 may, in some examples, perform a decoding pass generally reciprocal to the encoding pass described with respect to video encoder 100 from FIG. 12.

As explained with regard to the encoder 20, the inverse quantization unit 210, the inverse transform processing unit 212, the reconstruction unit 214 the loop filter 220, the decoded picture buffer (DPB) 230, the inter prediction unit 344 and the intra prediction unit 354 are also referred to as forming the “built-in decoder” of video encoder 20. Accordingly, the inverse quantization unit 310 may be identical in function to the inverse quantization unit 110, the inverse transform processing unit 312 may be identical in function to the inverse transform processing unit 212, the reconstruction unit 314 may be identical in function to reconstruction unit 214, the loop filter 320 may be identical in function to the loop filter 220, and the decoded picture buffer 330 may be identical in function to the decoded picture buffer 230. Therefore, the explanations provided for the respective units and functions of the video 20 encoder apply correspondingly to the respective units and functions of the video decoder 30.

The entropy decoding unit 304 is configured to parse the bitstream 21 (or in general encoded picture data 21) and perform, for example, entropy decoding to the encoded picture data 21 to obtain, e.g., quantized coefficients 309 and/or decoded coding parameters (not shown in FIG. 23), e.g. any or all of inter prediction parameters (e.g. reference picture index and motion vector), intra prediction parameter (e.g. intra prediction mode or index), transform parameters, quantization parameters, loop filter parameters, and/or other syntax elements.

The inverse quantization unit 310 may be configured to receive quantization parameters (QP) (or in general information related to the inverse quantization) and quantized coefficients from the encoded picture data 21 (e.g. by parsing and/or decoding, e.g. by entropy decoding unit 304) and to apply based on the quantization parameters an inverse quantization on the decoded quantized coefficients 309 to obtain dequantized coefficients 311, which may also be referred to as transform coefficients 311. The inverse quantization process may include use of a quantization parameter determined by video encoder 20 for each video block in the video slice (or tile or tile group) to determine a degree of quantization and, likewise, a degree of inverse quantization that should be applied.

Inverse transform processing unit 312 may be configured to receive dequantized coefficients 311, also referred to as transform coefficients 311, and to apply a transform to the dequantized coefficients 311 in order to obtain reconstructed residual blocks 213 in the sample domain. The reconstructed residual blocks 213 may also be referred to as transform blocks 313.

The reconstruction unit 314 (e.g. adder or summer 314) may be configured to add the reconstructed residual block 313, to the prediction block 365 to obtain a reconstructed block 315 in the sample domain, e.g. by adding the sample values of the reconstructed residual block 313 and the sample values of the prediction block 365.

The loop filter unit 320 (either in the coding loop or after the coding loop) is configured to filter the reconstructed block 315 to obtain a filtered block 321, e.g. to smooth pixel transitions, or otherwise improve the video quality. The loop filter unit 320 may comprise one or more loop filters such as a de-blocking filter, a sample-adaptive offset (SAO) filter or one or more other filters, e.g. a bilateral filter, an adaptive loop filter (ALF), a sharpening, a smoothing filters or a collaborative filters, or any combination thereof. Although the loop filter unit 320 is shown in FIG. 13 as being an in loop filter, in other configurations, the loop filter unit 320 may be implemented as a post loop filter.

The inter prediction unit 344 may be identical to the inter prediction unit 244 (in particular to the motion compensation unit) and the intra prediction unit 354 may be identical to the inter prediction unit 254 in function, and performs split or partitioning decisions and prediction based on the partitioning and/or prediction parameters or respective information received from the encoded picture data 21 (e.g. by parsing and/or decoding, e.g. by entropy decoding unit 304). Mode application unit 360 may be configured to perform the prediction (intra or inter prediction) per block based on reconstructed pictures, blocks or respective samples (filtered or unfiltered) to obtain the prediction block 365.

Mode application unit 360 is configured to determine the prediction information for a video block of the current video slice by parsing the motion vectors or related information and other syntax elements, and uses the prediction information to produce the prediction blocks for the current video block being decoded.

The embodiments of the video decoder 30 as shown in FIG. 13 may be configured to partition and/or decode the picture by using slices (also referred to as video slices), wherein a picture may be partitioned into or decoded using one or more slices (typically non-overlapping), and each slice may comprise one or more blocks (e.g. CTUs).

Embodiments of the video decoder 30 as shown in FIG. 13 may be configured to partition and/or decode the picture by using tile groups (also referred to as video tile groups) and/or tiles (also referred to as video tiles), wherein a picture may be partitioned into or decoded using one or more tile groups (typically non-overlapping), and each tile group may comprise, e.g. one or more blocks (e.g. CTUs) or one or more tiles, wherein each tile, e.g. may be of rectangular shape and may comprise one or more blocks (e.g. CTUs), e.g. complete or fractional blocks.

Other variations of the video decoder 30 can be used to decode the encoded picture data 21. For example, the decoder 30 can produce the output video stream without the loop filtering unit 320. For example, a non-transform based decoder 30 can inverse-quantize the residual signal directly without the inverse-transform processing unit 312 for certain blocks or frames. In another implementation, the video decoder 30 can have the inverse-quantization unit 310 and the inverse-transform processing unit 312 combined into a single unit.

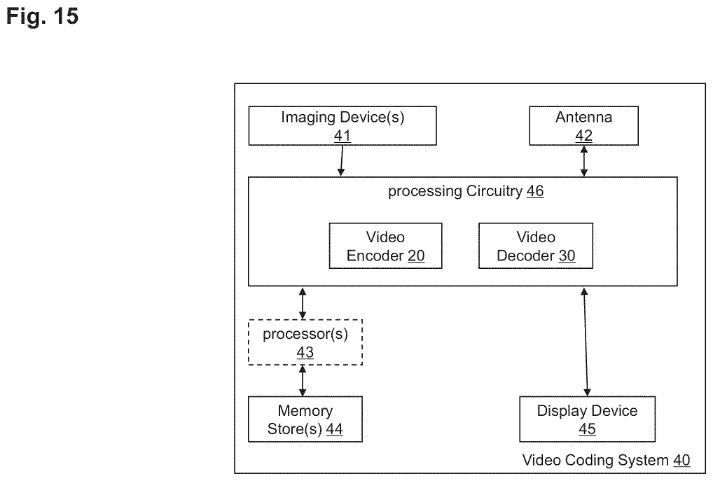

In the following embodiments of a video coding system 10, a video encoder 20 and a video decoder 30 are described based on FIGS. 14 and 15, with reference to the above mentioned FIGS. 12 and 13.

FIG. 14 is a schematic block diagram illustrating an example coding system 10, e.g. a video coding system 10 (or short coding system 10) that may utilize techniques of this present application. Video encoder 20 (or short encoder 20) and video decoder 30 (or short decoder 30) of video coding system 10 represent examples of devices that may be configured to perform techniques in accordance with various examples described in the present application.

As shown in FIG. 14, the coding system 10 comprises a source device 12 configured to provide encoded picture data 21 e.g. to a destination device 14 for decoding the encoded picture data 13.

The source device 12 comprises an encoder 20, and may additionally, i.e. optionally, comprise a picture source 16, a pre-processor (or pre-processing unit) 18, e.g. a picture pre-processor 18, and a communication interface or communication unit 22.

The picture source 16 may comprise or be any kind of picture capturing device, for example a camera for capturing a real-world picture, and/or any kind of a picture generating device, for example a computer-graphics processor for generating a computer animated picture, or any kind of other device for obtaining and/or providing a real-world picture, a computer generated picture (e.g. a screen content, a virtual reality (VR) picture) and/or any combination thereof (e.g. an augmented reality (AR) picture). The picture source may be any kind of memory or storage storing any of the aforementioned pictures.

In distinction to the pre-processor 18 and the processing performed by the pre-processing unit 18, the picture or picture data 17 may also be referred to as raw picture or raw picture data 17.

Pre-processor 18 is configured to receive the (raw) picture data 17 and to perform pre-processing on the picture data 17 to obtain a pre-processed picture 19 or pre-processed picture data 19. Pre-processing performed by the pre-processor 18 may, e.g., comprise trimming, color format conversion (e.g. from RGB to YCbCr), color correction, or de-noising. It can be understood that the pre-processing unit 18 may be optional component.

The video encoder 20 is configured to receive the pre-processed picture data 19 and provide encoded picture data 21 (further details were described above, e.g., based on FIG. 12, which may be further modified by replacing the loop filter with a loop CNN filter similarly as done in FIG. 13 for the decoder).

Communication interface 22 of the source device 12 may be configured to receive the encoded picture data 21 and to transmit the encoded picture data 21 (or any further processed version thereof) over communication channel 13 to another device, e.g. the destination device 14 or any other device, for storage or direct reconstruction.

The destination device 14 comprises a decoder 30 (e.g. a video decoder 30), and may additionally, i.e. optionally, comprise a communication interface or communication unit 28, a post-processor 32 (or post-processing unit 32) and a display device 34.

The communication interface 28 of the destination device 14 is configured receive the encoded picture data 21 (or any further processed version thereof), e.g. directly from the source device 12 or from any other source, e.g. a storage device, e.g. an encoded picture data storage device, and provide the encoded picture data 21 to the decoder 30.

The communication interface 22 and the communication interface 28 may be configured to transmit or receive the encoded picture data 21 or encoded data 13 via a direct communication link between the source device 12 and the destination device 14, e.g. a direct wired or wireless connection, or via any kind of network, e.g. a wired or wireless network or any combination thereof, or any kind of private and public network, or any kind of combination thereof.

The communication interface 22 may be, e.g., configured to package the encoded picture data 21 into an appropriate format, e.g. packets, and/or process the encoded picture data using any kind of transmission encoding or processing for transmission over a communication link or communication network.

The communication interface 28, forming the counterpart of the communication interface 22, may be, e.g., configured to receive the transmitted data and process the transmission data using any kind of corresponding transmission decoding or processing and/or de-packaging to obtain the encoded picture data 21.

Both, communication interface 22 and communication interface 28 may be configured as unidirectional communication interfaces as indicated by the arrow for the communication channel 13 in FIG. 14 pointing from the source device 12 to the destination device 14, or bi-directional communication interfaces, and may be configured, e.g. to send and receive messages, e.g. to set up a connection, to acknowledge and exchange any other information related to the communication link and/or data transmission, e.g. encoded picture data transmission.

The decoder 30 is configured to receive the encoded picture data 21 and provide decoded picture data 31 or a decoded picture 31 (further details were described above, e.g., based on FIG. 13 or FIG. 14).

The post-processor 32 of destination device 14 is configured to post-process the decoded picture data 31 (also called reconstructed picture data), e.g. the decoded picture 31, to obtain post-processed picture data 33, e.g. a post-processed picture 33. The post-processing performed by the post-processing unit 32 may comprise, e.g. color format conversion (e.g. from YCbCr to RGB), color correction, trimming, or re-sampling, or any other processing, e.g. for preparing the decoded picture data 31 for display, e.g. by display device 34.

The display device 34 of the destination device 14 is configured to receive the post-processed picture data 33 for displaying the picture, e.g. to a user or viewer. The display device 34 may be or comprise any kind of display for representing the reconstructed picture, e.g. an integrated or external display or monitor. The displays may, e.g. comprise liquid crystal displays (LCD), organic light emitting diodes (OLED) displays, plasma displays, projectors, micro LED displays, liquid crystal on silicon (LCoS), digital light processor (DLP) or any kind of other display.

Although FIG. 14 depicts the source device 12 and the destination device 14 as separate devices, embodiments of devices may also comprise both or both functionalities, the source device 12 or corresponding functionality and the destination device 14 or corresponding functionality. In such embodiments the source device 12 or corresponding functionality and the destination device 14 or corresponding functionality may be implemented using the same hardware and/or software or by separate hardware and/or software or any combination thereof.

As will be apparent for the skilled person based on the description, the existence and (exact) split of functionalities of the different units or functionalities within the source device 12 and/or destination device 14 as shown in FIG. 14 may vary depending on the actual device and application.

The encoder 20 (e.g. a video encoder 20) or the decoder 30 (e.g. a video decoder 30) or both encoder 20 and decoder 30 may be implemented via processing circuitry as shown in FIG. 15, such as one or more microprocessors, digital signal processors (DSPs), application-specific integrated circuits (ASICs), field-programmable gate arrays (FPGAs), discrete logic, hardware, video coding dedicated or any combinations thereof. The encoder 20 may be implemented via processing circuitry 46 to embody the various modules as discussed with respect to encoder 20 of FIG. 15 and/or any other encoder system or subsystem described herein. The decoder 30 may be implemented via processing circuitry 46 to embody the various modules as discussed with respect to decoder 30 of FIG. 13 (or FIG. 14) and/or any other decoder system or subsystem described herein. The processing circuitry may be configured to perform the various operations as discussed later. As shown in FIG. 15, if the techniques are implemented partially in software, a device may store instructions for the software in a suitable, non-transitory computer-readable storage medium and may execute the instructions in hardware using one or more processors to perform the techniques of this disclosure. Either of video encoder 20 and video decoder 30 may be integrated as part of a combined encoder/decoder (CODEC) in a single device, for example, as shown in FIG. 15.

Source device 12 and destination device 14 may comprise any of a wide range of devices, including any kind of handheld or stationary devices, e.g. notebook or laptop computers, mobile phones, smart phones, tablets or tablet computers, cameras, desktop computers, set-top boxes, televisions, display devices, digital media players, video gaming consoles, video streaming devices (such as content services servers or content delivery servers), broadcast receiver device, broadcast transmitter device, or the like and may use no or any kind of operating system. In some cases, the source device 12 and the destination device 14 may be equipped for wireless communication. Thus, the source device 12 and the destination device 14 may be wireless communication devices.

In some cases, video coding system 10 illustrated in FIG. 14 is merely an example and the techniques of the present application may apply to video coding settings (e.g., video encoding or video decoding) that do not necessarily include any data communication between the encoding and decoding devices. In other examples, data is retrieved from a local memory, streamed over a network, or the like. A video encoding device may encode and store data to memory, and/or a video decoding device may retrieve and decode data from memory. In some examples, the encoding and decoding is performed by devices that do not communicate with one another, but simply encode data to memory and/or retrieve and decode data from memory.

For convenience of description, embodiments of the present disclosure are described herein, for example, by reference to High-Efficiency Video Coding (HEVC) or to the reference software of Versatile Video coding (VVC), the next generation video coding standard developed by the Joint Collaboration Team on Video Coding (JCT-VC) of ITU-T Video Coding Experts Group (VCEG) and ISO/IEC Motion Picture Experts Group (MPEG). One of ordinary skill in the art will understand that embodiments of the present disclosure are not limited to HEVC or VVC.

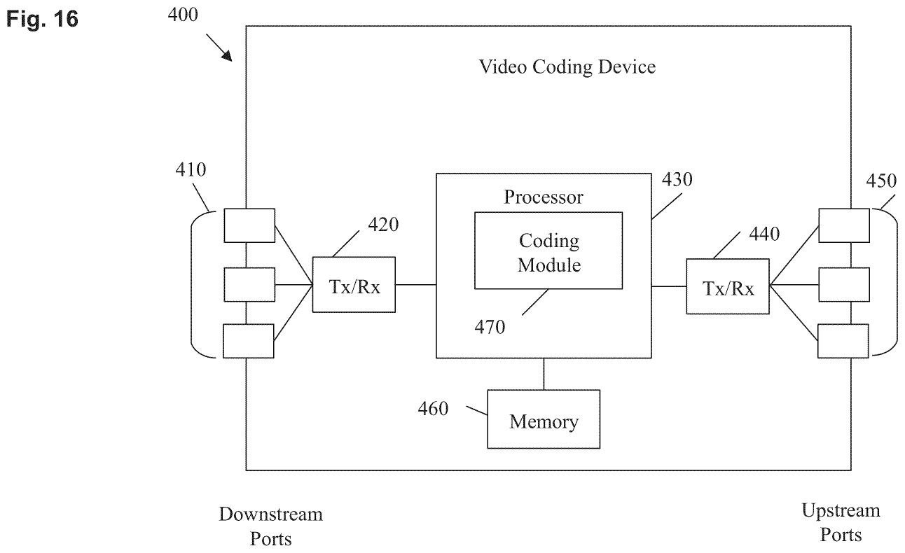

FIG. 16 is a schematic diagram of a video coding device 400 according to an embodiment of the disclosure. The video coding device 400 is suitable for implementing the disclosed embodiments as described herein. In an embodiment, the video coding device 400 may be a decoder such as video decoder 30 of FIG. 14 or an encoder such as video encoder 20 of FIG. 12.

The video coding device 400 comprises ingress ports 410 (or input ports 410) and receiver units (Rx) 420 for receiving data; a processor, logic unit, or central processing unit (CPU) 430 to process the data; transmitter units (Tx) 440 and egress ports 450 (or output ports 450) for transmitting the data; and a memory 460 for storing the data. The video coding device 400 may also comprise optical-to-electrical (OE) components and electrical-to-optical (EO) components coupled to the ingress ports 410, the receiver units 420, the transmitter units 440, and the egress ports 450 for egress or ingress of optical or electrical signals.

The processor 430 is implemented by hardware and software. The processor 430 may be implemented as one or more CPU chips, cores (e.g., as a multi-core processor), FPGAs, ASICs, and DSPs. The processor 430 is in communication with the ingress ports 410, receiver units 420, transmitter units 440, egress ports 450, and memory 460. The processor 430 comprises a coding module 470. The coding module 470 implements the disclosed embodiments described above. For instance, the coding module 470 implements, processes, prepares, or provides the various coding operations. The inclusion of the coding module 470 therefore provides a substantial improvement to the functionality of the video coding device 400 and effects a transformation of the video coding device 400 to a different state. Alternatively, the coding module 470 is implemented as instructions stored in the memory 460 and executed by the processor 430.

The memory 460 may comprise one or more disks, tape drives, and solid-state drives and may be used as an over-flow data storage device, to store programs when such programs are selected for execution, and to store instructions and data that are read during program execution. The memory 460 may be, for example, volatile and/or non-volatile and may be a read-only memory (ROM), random access memory (RAM), ternary content-addressable memory (TCAM), and/or static random-access memory (SRAM).

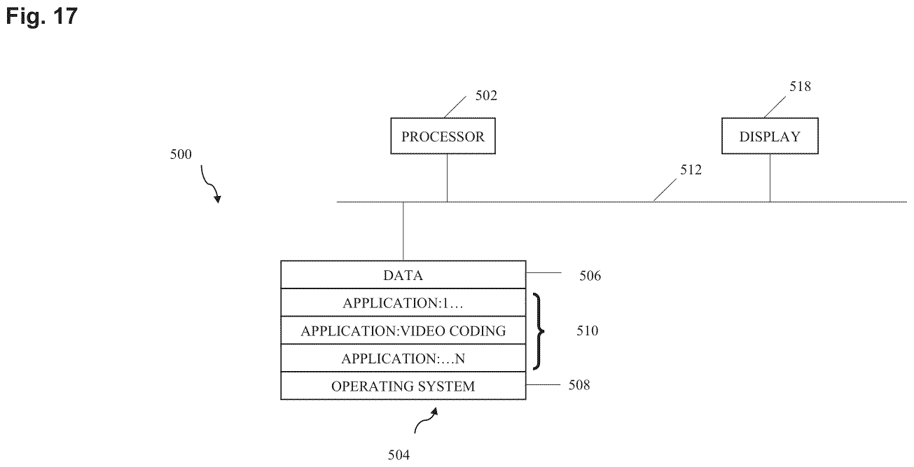

FIG. 17 is a simplified block diagram of an apparatus 500 that may be used as either or both of the source device 12 and the destination device 14 from FIG. 14 according to an exemplary embodiment.

A processor 502 in the apparatus 500 can be a central processing unit. Alternatively, the processor 502 can be any other type of device, or multiple devices, capable of manipulating or processing information now-existing or hereafter developed. Although the disclosed implementations can be practiced with a single processor as shown, e.g., the processor 502, advantages in speed and efficiency can be achieved using more than one processor.

A memory 504 in the apparatus 500 can be a read only memory (ROM) device or a random access memory (RAM) device in an implementation. Any other suitable type of storage device can be used as the memory 504. The memory 504 can include code and data 506 that is accessed by the processor 502 using a bus 512. The memory 504 can further include an operating system 508 and application programs 510, the application programs 510 including at least one program that permits the processor 502 to perform the methods described here. For example, the application programs 510 can include applications 1 through N, which further include a video coding application that performs the methods described herein, including the encoding and decoding using a neural network and the encoding and decoding the feature channels with different encoding parameters.

The apparatus 500 can also include one or more output devices, such as a display 518. The display 518 may be, in one example, a touch sensitive display that combines a display with a touch sensitive element that is operable to sense touch inputs. The display 518 can be coupled to the processor 502 via the bus 512.

Although depicted here as a single bus, the bus 512 of the apparatus 500 can be composed of multiple buses. Further, the secondary storage 514 can be directly coupled to the other components of the apparatus 500 or can be accessed via a network and can comprise a single integrated unit such as a memory card or multiple units such as multiple memory cards. The apparatus 500 can thus be implemented in a wide variety of configurations.

Although embodiments of the present disclosure have been primarily described based on video coding, it should be noted that embodiments of the coding system 10, encoder 20 and decoder 30 (and correspondingly the system 10) and the other embodiments described herein may also be configured for still picture processing or coding, i.e. the processing or coding of an individual picture independent of any preceding or consecutive picture as in video coding. In general only inter-prediction units 244 (encoder) and 344 (decoder) may not be available in case the picture processing coding is limited to a single picture 17. All other functionalities (also referred to as tools or technologies) of the video encoder 20 and video decoder 30 may equally be used for still picture processing, e.g. residual calculation 204/304, transform 206, quantization 208, inverse quantization 210/310, (inverse) transform 212/312, partitioning 262/362, intra-prediction 254/354, and/or loop filtering 220, 320, and entropy coding 270 and entropy decoding 304.

Embodiments, e.g. of the encoder 20 and the decoder 30, and functions described herein, e.g. with reference to the encoder 20 and the decoder 30, may be implemented in hardware, software, firmware, or any combination thereof. If implemented in software, the functions may be stored on a computer-readable medium or transmitted over communication media as one or more instructions or code and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limiting, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of inter-operative hardware units, including one or more processors as described above, in conjunction with suitable software and/or firmware.

Summarizing, the present disclosure relates to methods and apparatuses for generating from input frames of a video sequence a bitstream and generating therefrom back frames of said video sequence. For that purpose, synthesized frames are generated at a position by interpolation using input frames and determining a quality of the synthesize frame. Whether an indication of the position is included or an input frame at said position is encoded into the bitstream, depends on the synthesized frame's quality. When the synthesized frames meets a quality criteria, the position indication is included into the bitstream. Otherwise, the content of the input frame at said position is encoded. Hence, a minimal amount of input frames are encoded and sufficient to generate the frames of the video sequence, exploiting the position information of the synthesized frames, so as to generate them. Such a bitstream generating method may be advantageous in high-efficient CODECS where bitstreams are generated at strongly reduced bit cost.

### LIST OF SOME REFERENCE SIGNS

FIG. 8
800 encoding apparatus
810 processing circuitry
812 generating module
814 determining module
816 including module
818 encoding module
FIG. 9
900 decoding apparatus
910 processing circuitry
912 decoding module
914 parsing module
916 generating module

What is claimed is:

1. An apparatus for generating a bitstream representing input frames of a video sequence, the apparatus comprising:
a processing circuitry configured to generate the bitstream including:
generating a synthesized frame at a first position of a first input frame based on two or more input frames;
determining a quality measure for the synthesized frame;
based on determining that the quality measure fulfills a predetermined condition, including an indication of the first position into a bitstream portion; and
based on determining that the quality measure does not fulfill the predetermined condition, encoding content of the first input frame into the bitstream portion.

2. The apparatus according to claim 1, wherein the generating of the synthesized frame includes interpolating the synthesized frame based on one or more input frames preceding the synthesized frame and on one or more input frames succeeding the synthesized frame in a display order.

3. The apparatus according to claim 1, wherein the generating of the synthesized frame is performed by a neural network.

4. The apparatus according to claim 1, wherein the quality measure is any of peak signal to noise ratio (PSNR) resolution, bit depth, or a perceptual quality metric.

5. The apparatus according to claim 1, wherein the first input frame, based on determining that the quality measure does not fulfill the predetermined condition, can be coded as any of an intra-predicted frame I, a unidirectional inter-prediction frame P, and a bidirectional inter-prediction frame B, corresponding respectively to frame types I, P, and B.

6. The apparatus according to claim 1, wherein
the synthesized frame is generated from the two or more input frames, and
the indication indicates the first position within a Group of Pictures (GOP) at which the synthesized frame is to be generated.

7. The apparatus according to claim 6, wherein a number of synthesized frames generated for the GOP is based on a predefined look ahead constant determining a maximum number of synthesized frames that can be generated for the GOP, or wherein:
the GOP includes two or more coded frames comprising a starting frame having the frame type I and an ending frame of the GOP, and
the processing circuitry is further configured to:
assign one of frame types P and B in accordance with a predefined GOP pattern of frame types to each of the frames within the GOP different from the starting frame; and
encode the content of the each of the frames within the GOP into the bitstream portion, or wherein:
the indication of the first position includes positions of the coded frames, or wherein:
the processing circuitry is further configured to:
detect a scene change based on the frames of the GOP; and
assign a frame to be encoded at which the scene change occurs the frame type I.

8. The apparatus according to claim 1, wherein
the processing circuitry is configured to determine a set of one or more positions, including the first position, of a next coded frame within a Group of Pictures (GOP), the GOP including, as coded input frames, a starting frame with a start position and an ending frame with an end position, wherein the start position and the end position are in display order, including:
generating for a GOP size and a predefined look ahead constant recursively in coding order one or more synthesized frames at a respective current position between the start position and the end position from the starting frame and the ending frame;
determining the quality measure for each of the synthesized frames;
based on determining that the quality measure fulfills the predetermined condition for each of the synthesized frames:
determining the ending frame as the next frame to be encoded and encode the content of the ending frame at the end position into the bitstream portion;
based on determining that the quality measure does not fulfill predetermined condition for any of the one or more synthesized frames:
continuing the recursion by bisecting the GOP size and using the start position and the end position of the input frames of the respective bisected GOP; or
determining the coded input frame immediately following the starting frame in the display order as the next frame to be encoded and encode the content of an input frame at the respective current position into the bitstream portion,
wherein the predefined look ahead constant determines a maximum number of the synthesized frames that can be generated for the GOP.

9. An apparatus for generating frames of a video sequence from a bitstream representing the video sequence, the apparatus comprising:
a processing circuitry configured to generate the frames including:
decoding from a bitstream portion of the bitstream content of two or more frames of the video sequence;
parsing the bitstream portion for an indication of a first position; and
generating, based on the parsed indication, a synthesized frame as a frame of the video sequence at said first position based on two or more previously generated frames.

10. The apparatus according to claim 9, wherein the generating of the synthesized frame includes interpolating the synthesized frame based on one or more previously generated frames preceding the synthesized frame and on one or more previously generated frames succeeding the synthesized frame in a display order.

11. The apparatus according to claim 9, wherein the generating of the synthesized frame is performed by a neural network.

12. The apparatus according to claim 9, wherein the decoded two or more frames being any of an intra-predicted frame I, an unidirectional inter-prediction frame P, and a bidirectional inter-prediction frame B, corresponding to frame types I, P, and B.

13. The apparatus according to claim 9, wherein the indication indicates said first position within a Group of Pictures, GOP, at which the synthesized frame is generated.

14. The apparatus according to claim 13, wherein the indication of said first position includes positions of the decoded two or more frames, with said first position and the positions of the decoded two or more frames being in display order of the GOP.

15. The apparatus according to claim 13, wherein
the processing circuitry is further configured to put the decoded two or frames into a decoded frame buffer if one or more frames depend on the frame at said first position

16. The apparatus according to claim 13, wherein
the GOP includes two or more decoded frames comprising a starting frame an ending frame of the GOP, the starting frame having frame type I and the ending frame having a frame type B or P, and
the processing circuitry is further configured to:
determine, based on the parsed indication, a position difference between the two decoded frames having successive positions in display order;
determine, based on the position difference, a number of synthesized frames generated in display order between the two decoded frames; and
generate in decoding order the synthesized frames in accordance with the number at respective positions between the two decoded frames based on the position difference.

17. The apparatus according to claim 13, wherein the two or more decoded frames of the GOP include one or more decoded frames of frame type I having a corresponding position in display order between the starting frame and the ending frame of the GOP.

18. The apparatus according to claim 9, wherein the synthesized frame pertains to a Group of Pictures, GOP, of a predefined GOP structure, and the indication indicates said first position within the GOP at which the synthesized frame is generated.

19. The apparatus according to claim 18, wherein
the GOP includes two or more already generated frames, the GOP comprising a starting frame with a start position and an ending frame with an end position, wherein the start position and the end position are in display order, and
the processing circuitry is further configured to recursively:
parse the bitstream for the indication of a current position, the current position being between the start position and the end position;
when said indication is parsed:
generate in decoding order the synthesized frame at the current position from the starting frame and the ending frame;
when said indication is not parsed:
decode from the bitstream portion content of a current frame being at the current position;
continue the recursion using the starting frame and, as the ending frame, the synthesized frame or the decoded frame at the current position, and/or respectively using, as the starting frame, the synthesized frame or the decoded frame at the current position, and the ending frame.

20. The apparatus according to claim 18, wherein
the processing circuitry is further configured to put the generated frame into a decoded frame buffer if one or more generated frames depend on the frame at said first position.

21. The apparatus according to claim 9, wherein the indication indicates said first position within a Group of Pictures, GOP, at which the synthesized frame is generated and the bitstream portion includes an indication of one or more GOP sizes.

22. The apparatus according to claim 21, wherein the GOP size corresponds to a difference in position between successive decoded frames, or wherein
the GOP comprises already two decoded frames used as a starting frame with a start position and an ending frame with an end position, wherein the start position and the end position are in display order, and
the processing circuitry is further configured to recursively:
parse the bitstream portion for the indication of a first GOP size among the one or more GOP sizes;
generate for said first GOP size in decoding order one or more synthesized frames at a respective current position in display order between the start position and the end position from the starting frame and the ending frame;
continue the recursion using, as the starting frame, the ending frame of previous recursion step and using, as the ending frame, the decoded frame based on a next GOP size subsequent to said first GOP size.

23. A method for generating a bitstream representing input frames of a video sequence, the method comprising steps of generating the bitstream including:
generating (S1010) a synthesized frame at a first position of a first input frame based on two or more input frames;
determining (S1020) a quality measure for the synthesized frame;
when the quality measure fulfills a predetermined condition (S1030 “YES”):
including (S1040) an indication of said first position into a bitstream portion; and
when the quality measure does not fulfill the predetermined condition (S1030 “NO”):
encoding (S1050) content of said first input frame into the bitstream portion.

24. A method for generating frames of a video sequence from a bitstream representing the video sequence, the method comprising steps of generating the frames including:
decoding (S1110) from a bitstream portion of the bitstream content of two or more frames of the video sequence;
parsing (S1120) the bitstream portion for an indication of a first position; and
generating (S1130), based on the parsed indication, a synthesized frame as a frame of the video sequence at said first position based on two or more previously generated frames.

25. The computer-readable non-transitory medium storing a program, including instructions which when executed on one or more processors cause the one or more processors to perform the method according to claim 23.
